(19) United States
(12) Patent Application Publication
(10) Pub. No.: US 2024/0052191 A1
(43) Pub. Date: Feb. 15, 2024

(54) Electronic Telecommunications Articles Comprising Crosslinked Fluoropolymer and Fluoropolymer Particles, Compositions and Methods

(71) Applicant: 3M INNOVATIVE PROPERTIES COMPANY, St. Paul, MN (US)

(72) Inventors: Cheng Li, Shanghai (CN); Naiyong Jing, St. Paul, MN (US); Zai-Ming Qiu, Woodbury, MN (US); Klaus Hintzer, Kastl (DE); Maria C. Lindsay, Minneapolis, MN (US)

(21) Appl. No.: 18/266,619

(22) PCT Filed: Nov. 24, 2021
(86) PCT No.: PCT/CN2021/132654

§ 371 Date: Jun. 12, 2023

Related U.S. Application Data
(60) Provisional application No. 63/128,999, filed on Dec. 22, 2020.

(51) Int. Cl. C09D 127/18; H01B 3/44

(52) U.S. Cl. CPC C09D 127/18; H01B 3/445; C08K 2201/005; C08K 3/36

(57) ABSTRACT

Electronic telecommunication articles are described comprising a crosslinked fluoropolymer layer comprising fluoropolymer particles having a particle size of greater than 1 micron. In typical embodiments, the crosslinked fluoropolymer layer is a in substrate, patterned (e.g. photoresist) layer, insulating layer, passivation layer, cladding, protective layer, or a combination thereof. Also describes are methods of making an electronic telecommunications article and method of forming a patterned fluoropolymer layer. The fluoropolymer preferably comprises at least 80, 85, or 90% by weight of polymerized units of perfluorinated monomers and cure sites selected from nitrile, iodine, bromine, and chlorine. Illustrative electronic communication articles include integrated circuits, printed circuit boards, antennas, and optical fiber cables. Fluoropolymer compositions are also described.

### SUMMARY

In one embodiment, electronic telecommunication articles are described comprising a crosslinked fluoropolymer layer and fluoropolymer particles having a particle size of greater than 1 micron. In typical embodiments, the crosslinked fluoropolymer layer is a substrate, patterned (e.g. photoresist) layer, insulating layer, passivation layer, cladding, protective layer, or a combination thereof.

in another embodiment, a method of making an electronic telecommunications article is described comprising providing a film or coating solution comprising a fluoropolymer and fluoropolymer particles having a particle size of greater than 1 micron; and applying the film or coating solution to a component of an electronic telecommunications article. The coating solution typically further comprises a fluorinated solvent. The method further comprises crosslinking the fluoropolymer by exposure to heat, actinic radiation, or a combination thereof.

In another embodiment, a method of forming a patterned fluoropolymer layer is described comprising applying a fluoropolymer film comprising fluoropolymer particles having a particle size of greater than 1 micron to a substrate; selectively crosslinking portions of the fluoropolymer film by exposure to actinic radiation; and removing uncrosslinked portions of the fluoropolymer film.

In each of these embodiments, the fluoropolymer preferably comprises at least 80, 85, or 90% by weight of polymerized units of perfluorinated monomers and cure sites selected from nitrite, iodine, bromine, and chlorine.

Illustrative electronic communication articles include integrated circuits, printed circuit boards, antennas, and optical fiber cables.

### BRIEF DESCRIPTION OF THE DRAWINGS

FIG. 1 is a schematic cross-sectional diagram of forming a patterned fluoropolymer layer by photolithography in an illustrative embodiment of the manufacture of an integrated circuit (IC).

FIG. 2 is a perspective view of an illustrative printed circuit board (PCB) including integrated circuits;

FIGS. 3A and 3B are cross-sectional diagrams of illustrative fluoropolymer passivation and insulating layers.

FIG. 4 is a plan view of an illustrative antenna of a mobile computer device.

FIGS. 5A and 5B are perspective views of illustrative antennas of a telecommunications tower.

FIG. 6 is a cross-sections diagram of an illustrative optical fiber cable.

### DETAILED DESCRIPTION

Presently described are certain fluoropolymer compositions (e.g. films and coatings) for use in electronic telecommunication articles. As used herein, electronic refers to devices using the electromagnetic spectrum (e.g. electons, photons); whereas telecommunication is the transmission of signs, signals, messages, words, writings, images and sounds or information of any nature by wire, radio, optical or other electromagnetic systems.

Polyimide materials are used extensively in the electronic telecommunications industry. The structure of poly-oxydiphenylene-pyromellitimide, “Kapton” is as follows:

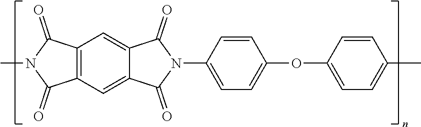

Polyimide films exhibited good insulating properties with dielectric constants values in the range of 2.78-3.48 and dielectric loss between 0.01 and 0.03 at 1Hz at room temperature,

Perfluoropolymers can have substantially lower dielectric constants and dielectric loss properties than polyimides which is particularly important for fifth generation cellular network technology (“5G”) articles. For example, crosslinked fluoropolymer compositions described herein can have a dielectric constant (Dk) of less than 2.75, 2.70, 2.65, 2.60, 2.55, 2.50, 2.45, 2.40, 2.35, 2.30, 2.25, 2.20, 2.15, 2,10, 2.05, 2.00, or 1.95. In some embodiments, the dielectric constant is at least 2.02, 2.03, 2.04, 2.05. Further, the crosslinked fluoropolymer compositions described herein can have a low dielectric loss, typically less than 0.01, 0.009, 0.008, 0.007, 0.006, 0.005, 0.004, 0.003, 0.002, 0.001, 0.0009, 0.0008, 0.0007, 0.0006, 0.0005, 0.0004, 0.0003. In some embodiments, the dielectric loss is at least 0.00022, 0.00023. 0.00024, 0.00025. The dielectric properties (e.g. constant and loss) can be determined according to the test method described in the examples. As the number of non-fluorine atoms increases (e.g. number of carbon-hydrogen and/or carbon-oxygen bonds increases) the dielectric constant and dielectric loss also typically increases.

However, perfluoropolymers have not been used in place of polyimides is various electronic telecommunications articles are least in part by the lack of perfluoropolymer materials that can be crosslinked by exposure to actinic and more preferably ultraviolet radiation. Crosslinked perfluoropolymer materials can have improved mechanical properties in comparison to uncrosslinked perfluoropolymer materials. Hence, the perfluoropolymer compositions described are suitable for use in place of polyimides in various electronic telecommunication articles.

In one embodiment, the electronic telecommunication article is an integrated circuit or in other words a silicon chip or microchip, i.e. a microscopic electronic circuit array formed by the fabrication of various electrical and electronic components (resistors, capacitors, transistors, and so on) on a semiconductor material (silicon) wafer.

In one embodiment, the fluoropolymer composition described herein can be used to form a patterned (e.g. photoresist) layer. Fluoropolymer compositions as described herein can be used as a negative photoresist in a variety of fabrication techniques. In some embodiments, (e.g. sacrificial) photoresist materials are etched away and do not remain in the finished article. In other embodiments, the photoresist material may be present in the finished article. Various integrated circuit designs have been described in the literature.

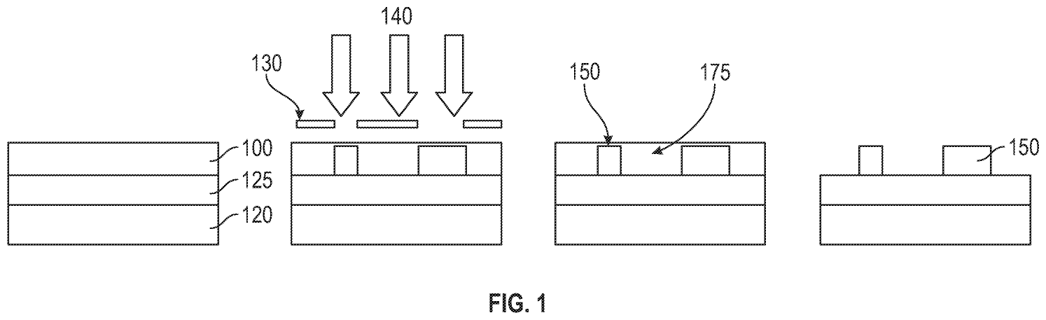

With reference to FIG. 1, in one embodiment, a method of forming a patterned fluoropolymer layer is described comprising applying a fluoropolymer film 100 to a substrate (e.g.

silicon wafer 120 or the passivation (e.g. SiO₂) layer 125 coated surface thereof); selectively crosslinking portions of the fluoropolymer film by exposure to actinic radiation; and removing uncrosslinked portions of the fluoropolymer

In some embodiments, the method further comprises providing a mask (e.g. photomask) 130 having one or more opening between the fluoropolymer film 100 and a source of actinic (e.g. e-beam or UV) radiation 140 and exposing the fluoropolymer film to actinic radiation through at least one opening of the mask.

As known in the art, the mask includes actinic energy (e.g. UV light) transmitting portions and portions that are non-transmitting of actinic energy (e.g. UV light). Photomasks typically comprise a transparent substrate, with a non-transmitting mask pattern on the surface of the substrate. The substrate is typically (e.g. highly pure quartz) glass, that is transparent to the illumination (i.e. wavelengths and intensity) of the photolithography process employed. The mask is typically prepared by selective deposition or selective etching of a mask material. Common non-light-transmitting mask materials include chrome metal, iron oxide, molybdenum silicide, etc., as known in the art.

After exposure, the fluoropolymer film comprises a patterned fluoropolymer layer comprising portions of cured or in other words crosslinked fluoropolymer 150 and portions of uncured or in other words uncrosslinked fluoropolymer 175.

In some embodiments, the method further comprises removing portions of uncrosslinked fluoropolymer film by dissolving the uncrosslinked portions in a solvent 160 (e.g. washing the fluoropolymer film with fluorinated solvent). The portions of cured or in other words crosslinked fluoropolymer 150 remains on the surface of the substrate as a patterned fluoropolymer layer. In this embodiment, the substrate or (e.g. SiO₂) coated surface thereof that comes in contact with the solvent is substantially insoluble in the solvent utilized for removing the uncrosslinked portions of the fluoropolymer film. In favored embodiments, the solvent is a fluorinated solvent.

In some embodiments, particularly when it is desirable to apply a thin fluoropolymer film to the substrate, the method comprises applying a coating solution (e.g. spin coating) to the substrate, wherein the coating solution comprises a fluorinated solvent and a fluoropolymer. In some embodiments, the fluoropolymer preferably comprises predominantly polymerized units of perfluorinated monomers and cure sites. The coating further comprises fluoropolymer particles and a curing agent that reacts with the cure sites in the presence of actinic (e.g. UV) radiation thereby crosslinking the fluoropolymer. The method typically comprises removing the fluorinated solvent (e.g. by evaporation). In this embodiment, the substrate or (e.g. SiO₂) coated surface thereof that comes in contact with the solvent is substantially insoluble in the fluorinated solvent of the coating solution. The fluorinated solvent for removing the uncrosslinked portions of the fluoropolymer film and the fluorinated solvent of the coating solution can be the same or different fluorinated solvents. Further, the method typically comprises recycling, or in other words reusing, the fluorinated solvent utilized to remove the uncrosslinked portions of the fluoropolymer film and/or the fluorinated solvent of the coating solution.

In other embodiments, the uncured portions 175 may be removed with other solventless methods, such as laser ablation.

The patterned fluoropolymer layer can be used to fabricate other layers such as a circuit of patterned electrode materials. Suitable electrode materials and deposition methods are known in the art. Such electrode materials include, for example, inorganic or organic materials, or composites of the two. Exemplary electrode materials include polyaniline, polypyrrole, poly(3,4-ethylenedioxythiophene) (PEDOT) or doped conjugated polymers, further dispersions or pastes of graphite or particles of metal such as Au, Ag, Cu, Al, Ni or their mixtures as well as sputter-coated or evaporated metals such as Cu, Cr, Pt/Pd, Ag, Au, Mg, Ca, Li or mixtures or metal oxides such as indium tin oxide (ITO), F-doped ITO, GZO (gallium doped zinc oxide), or AZO (aluminium doped zinc oxide). Organometallic precursors may also be used and deposited from a liquid phase.

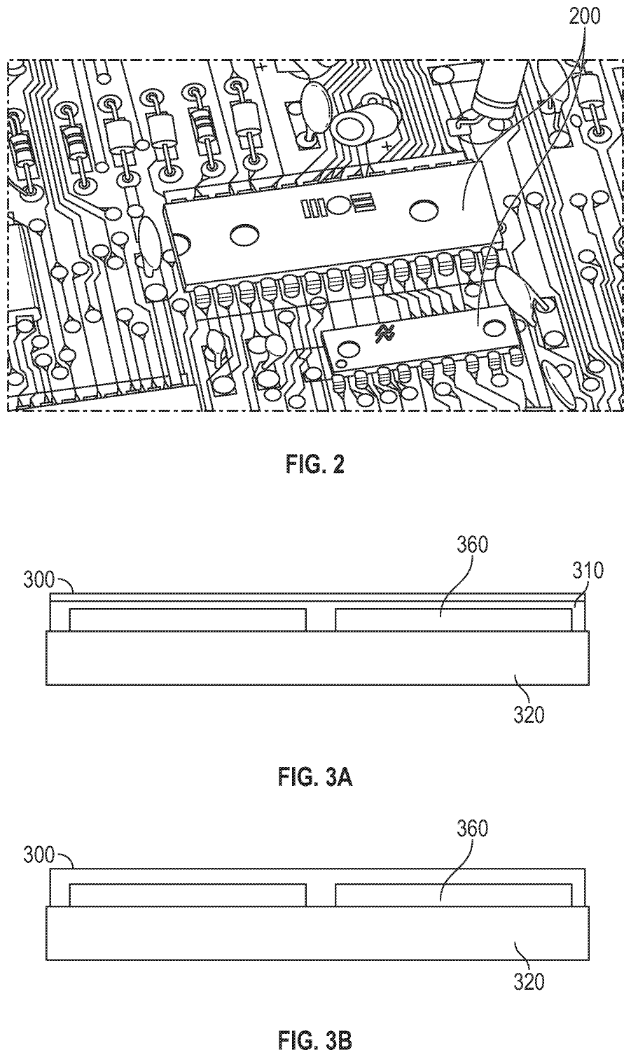

In another embodiment, the fluoropolymer (e.g. photoresist) layer can be disposed upon a metal (e.g. copper) substrate in the manufacture of a printed circuit board (PCB). An illustrative perspective view of a printed circuit board is depicted in FIG. 2. A printed circuit board, or PCB, is used to mechanically support and electrically connect electronic components using conductive pathways, tracks or signal traces etched from (e.g. copper) metal sheets laminated onto a non-conductive substrate. Such boards are typically made from an insulating material such as glass fiber reinforced (fiberglass) epoxy resin or paper reinforced phenolic resin. The pathways for electricity are typically made from a negative photoresist, as previously described. Thus, in this embodiment, the crosslinked fluoropolymer is disposed on the surface of the (e.g. copper) metal substrate. Portions of uncrosslinked fluoropolymer are removed to form the conductive (e.g. copper) pathways. Crosslinked fluoropolymer (e.g. photoresist) remain present, disposed between the conductive (e.g. copper) pathways of the printed circuit board. Solder is used to mount components on the surface of these boards. In some embodiments, the printed circuit board further comprises integrated circuits 200, as depicted in FIG. 2. Printed circuit board assemblies have an application in almost every electronic article including computers, computer printers, televisions, and cell phones.

In another embodiment, the crosslinked fluoropolymer film described herein can be utilized as an insulating layer, passivation layer, and/or protective layer in the manufacture of integrated circuits.

With reference to FIG. 3A, in one embodiment, a thin fluoropolymer film 300 (e.g. typically having a thickness less than 50, 40, or 30 nm) can be disposed on a passivation layer 310 (e.g. SiO₂) disposed on an electrode patterned 360 silicon chip 320.

With reference to FIG. 3B, in another embodiment, a thicker fluoropolymer film 300 (e.g. typically having a thickness of at least 100, 200, 300, 400, 500 nm) can be disposed on an electrode patterned 360 silicon chip 320. In this embodiment, the fluoropolymer layer may function as both a passivation layer and an insulating layer. Passivation is the use of a thin coating to provide electrical stability by isolating the transistor surface from electrical and chemical conditions of the environment.

In another embodiment, the crosslinked fluoropolymer film described herein can be utilized as a substrate for antennas. The antenna of the transmitter emits (e.g. high frequency) energy into space while the antenna of the receiver catches this and converts it into electricity.

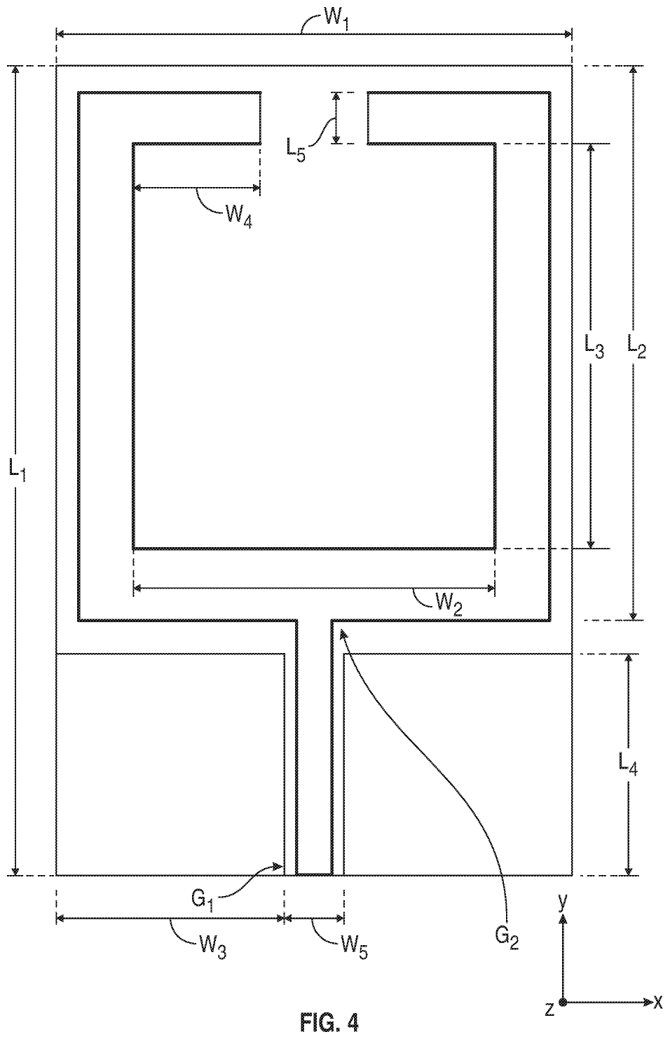

The patterned electrodes of an antenna can also be formed from photolithography. Screen printing, flexography, and ink jet printing can also be utilized to form the electrode pattern as known in the art. Various antenna designs for (e.g. mobile) computing devices (smart phone, tablet, laptop, desktop) have been described in the literature. One representative split ring monopole antenna is depicted in FIG. 4 having the following dimensions in microns.

| | | | |
|---|---|---|---|
| L₁ | 38 | W₁ | 25 |
| L₂ | 26 | W₂ | 18 |
| L₃ | 19 | W₃ | 10.5 |
| L₄ | 9.5 | W₄ | 6.5 |
| L₅ | 3 | W₅ | 2 |
| G₁ | 2 | G₂ | 0.5 |

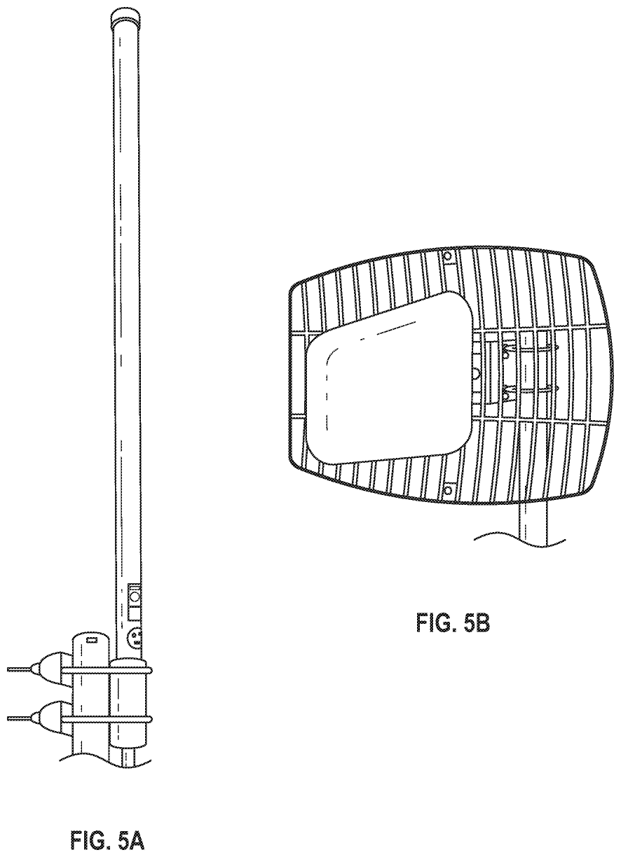

The low dielectric fluoropolymer films and coatings described herein can also be utilized as insulating and protective layers of transmitter antennas of cell towers and other (e.g. outdoor) structures. There are two major types of antennas used in cell towers. FIG. 5A is depicts a representative omnidirectional (e.g. dipole) antenna used to transmit/receive in any direction. FIG. 5B is a representative directional antenna used to transmit/receive in particular desired direction only such as horn antennas of circular and rectangular type.

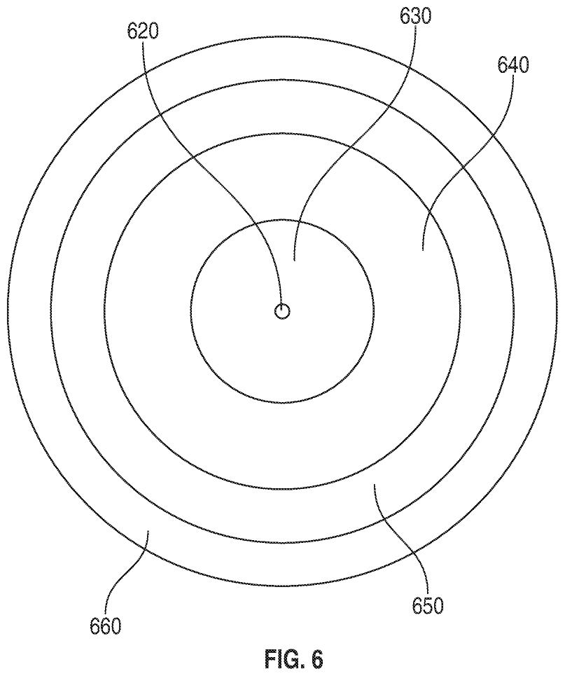

In another embodiment, the low dielectric fluoropolymer compositions described herein may also be utilized in fiber optic cable. With reference to FIG. 6, fiber optic cable typically includes five main components: the core which is typically highly pure (e.g. silica) glass 620, cladding 630, coating (e.g. first inner protective layer) 640, strengthening fibers 650,, and outer jacket (i.e. second outer protective layer) 660. The function of the cladding is to provide a lower refractive index at the core interface in order to cause reflection within the core so that light waves are transmitted through the fiber. The coating over the cladding is typically present to reinforce the fiber core, help absorb shocks, and provide extra protection against excessive cable bends. The low dielectric fluoropolymer compositions described herein can be used as the cladding, coating, outer jacket, or combination thereof.

In other embodiments, the low dielectric fluoropolymer films and coatings described herein can also be utilized for flexible cables and as an insulating film on magnet wire. For example, in a laptop computer, the cable that connects the main logic board to the display (which must flex every time the laptop is opened or closed) may be a low dielectric fluoropolymer composition as described herein with copper conductors.

The electronic telecommunication article is typically not a sealing component of equipment used in wafer and chip production.

One of ordinary skill in the art appreciates that the low dielectric fluoropolymer compositions described herein can be utilized in various electronic telecommunication articles, particularly in place of polyimide, and such utility is not limited to the specific articles described herein.

The fluoropolymers described herein are copolymers that comprise predominantly, or exclusively, (e.g. repeating) polymerized units derived from two or more perfluorinated comonomers. Copolymer refers to a polymeric material resulting from the simultaneous polymerization of two or more monomers. In some embodiments, the comonomers include tetrafluoroethene (TFE) and one or more unsaturated perfluorinated (e.g. alkenyl, vinyl) alkyl ethers.

In some favored embodiments, the one or more unsaturated perfluorinated alkyl ethers are selected from the general formula:

R_{f}˜O˜(CF₂)—CF═CF₂

wherein n is 1 (allyl ether) or 0 (vinyl ether) and R_{f} represents a perfluoroalkyl residue which may be interrupted once or more than once by an oxygen atom. R_{f} may contain up to 10 carbon atoms, e.g. 1, 2, 3, 4, 5, 6, 7, 8, 9 or 10 carbon atoms. Preferably R_{f} contains up to 8, more preferably up to 6 carbon atoms and most preferably 3 or 4 carbon atoms. In one embodiment R_{f} has 3 carbon atoms. In another embodiment R_{f} has 1 carbon atom. R_{f} may be linear or branched, and it may contain or not contain a cyclic unit. Specific examples of R_{f} include residues with one or more ether functions including but not limited to:
—(CF₂)—O—C₃F₇,
—(CF₂)₂—O—C₂F₅,
—(CF₂)ᵣ₃—O—CF₃,
—(CF₂—O)—C₃F₇,
—(CF₂—O)₂—C₂F₅,
—(CF₂—O)₃—CF₃,
—(CF₂CF₂—O)—C₃F₇,
—(CF₂CF₂—O)₃—CF₃,

Other specific examples for R_{f} include residues that do not contain an ether function and include but are not limited to —C₄F₉, —C₃F₇, —C₂F₅, —CF₃, wherein the C₄ and C₃ residues may be branched or linear, but preferably are linear.

Specific examples of suitable perfluorinated alkyl vinyl ethers (PAVE's) and perfluorinated alkyl allyl ethers (PAAE's) include but are not limited to perfluoro (methyl vinyl) ether (PMVE), perfluoro (ethyl vinyl) ether (PEVE), perfluoro (n-propyl vinyl) ether (PPVE-1), perfluoro-2-propoxypropylvinyl ether (PPVE-2), perfluoro-3-methoxy-n-propylvinyl ether, perfluoro-2-methoxy-ethylvinyl ether, CF₂═CF—O—CF₂—O—C₂F₅, CF₂═CF—O—CF₂—O—CF₂O—C₃F₇, CF₃—(CF₂)₂—O—CF(CF₃)—CF₂—O—CF(CF₃)—CF₂—O—CF═CF₂ and their allyl ether homologues. Specific examples of allyl ethers include CF₂═CF—CF₂—O—CF₃, CF₂═CF—CF₂—O—C₃C₇, CF₂═CF—CF₂—O—(CF₃)₃—O—CF₃.

Further examples include but are not limited to the vinyl ether described in European patent application EP 1,997,795 B1.

Perfluorinated ethers as described above are commercially available, for example from Antes Ltd., St. Petersburg, Russia and other companies or may be prepared according to methods described in U.S. Pat. No. 4,349,650 (Krespan) or European Patent 1,997,795, or by modifications thereof as known to a skilled person.

In some embodiments, the one or more unsaturated perfluorinated alkyl ethers comprises unsaturated cyclic perfluorinated alkyl ethers, such as 2,2-bistrifluoromethyl-4,5-difluoro-1,3 dioxole, In other embodiments, the fluoropolymer is substantially free of unsaturated cyclic perfluorinated alkyl ethers, such as 2,2-bistrifluoromethyl-4,5-difluoro-1,3 dioxole. By substantially free it is meant that the amount is zero or sufficiently low such the fluoropolymer properties are about the same.

In some favored embodiments, the fluoropolymers are derived predominantly or exclusively from perfluorinated comonomers including tetrafluoroethene (TFE) and one or more of the unsaturated perfluorinated alkyl ethers described above. “Predominantly” as used herein means at least 80, 85, or 90% by weight based on the total weight of the fluoropolymer, of the polymerized units of the fluoropolymer are derived from such perfluorinated comonomers such as tetrafluoroethene (TFE) and one or more unsaturated perfluorinated alkyl ethers. In some embodiments, the fluoropolymer comprises at least 81, 82, 83, 84, 85, 86, 87, 88, 90, 91, 92, 93, 94, 95, 96, or 97% by weight or greater of such perfluorinated comonomers, based on the total weight of the fluoropolymer. The fluoropolymers may contain at least 40, 45, or 50% by weight of polymerized units derived from TFE. In some embodiments, the maximum amount of polymerized units derived from TEE is no greater than 60% by weight.

The fluoropolymer typically comprises polymerized units derived from one or more of the unsaturated perfluorinated alkyl ethers (PAVE) (e.g. MINT, PAAE or a combination thereof), in an amount of at least 10, 15, 20, 25, 30, 45, or 50% by weight, based on the total polymerized monomer units of the fluoropolymer. In some embodiments, the fluoropolymer comprises no greater than 50, 45. 40, or 35% by weight of polymerized units derived from one or more of the unsaturated perfluorinated alkyl ethers (PMVE, PAAE or a combination thereof), based on the total polymerized monomer units of the fluoropolymer. The molar ratio of units derived from TFE to the perfluorinated alkly ethers described above may be, for example, from 1:1 to 5:1. In some embodiments, the molar ratio ranges from 1.5:1 to 3:1.

The fluoropolymers may be thermoplastic but, in a preferred embodiment, the fluoropolymer is amorphous. As used herein, amorphous fluoropolymers are materials that contain essentially no crystallinity or possess no significant melting point (peak maximum) as determined by differential scanning calorimetry in accordance with DIN EN ISO 11357-3:2013-04 under nitrogen flow and a heating rate of 10° C./min. Typically, amorphous fluoropolymers have a glass transition temperature (Tg) of less than 26° C., less than 20° C., or less than 0° C., and for example from −40° C. to 20° C., or −50° C. to 15° C. or −55° C. to 10° C. The fluoropolymers may typically have a Mooney viscosity (ML 1+10 at 121° C.) of from about 2 to about 150, for example from 10 to 100, or from 20 to 70. For amorphous polymers containing cyclic perfluorinated alky ether units, the glass transition temperature is typically at least 70° C., 80° C., or 90° C., and may range up to 220° C., 250° C., 270° C., or 290° C. The MEI (297° C./5 kg) is between 0.1-1000 g/10 min.

In other embodiments, the amorphous fluoropolymer may have a melt point of less than 150°C or 100° C.

The fluoropolymer is preferably a curable fluoropolymer that contains one or more cure sites. Cure sites are functional groups that react in the presence of a curing agent or a curing system to cross-link the polymers. The cure sites are typically introduced by copolymerizing cure-site monomers, which are functional comonomers already containing the cure sites or precursors thereof. One indication of crosslinking is that the dried and cured coating composition was not soluble in the fluorinated solvent of the coating.

The cure sites may be introduced into the polymer by using cure site monomers, i.e. functional monomers as will he described below, functional chain-transfer agents and starter molecules. The fluoroelastomers may contain cure sites that are reactive to more than one class of curing agents.

The curable fluoroelastomers may also contain cure sites in the backbone, as pendent groups, or cure sites at a terminal position. Cure sites within the fluoropolymer backbone can he introduced by using a suitable cure-site monomer. Cure site monomers are monomers containing one or more functional groups that can act as cure sites or contain a precursor that can be converted into a cure site.

In some embodiments, the cure sites comprise iodine or bromine atoms.

Iodine-containing cure site end groups can be introduced by using an iodine-containing chain transfer agent in the polymerization. Iodine-containing chain transfer agents will be described below in greater detail, Halogenated redox systems as described below may be used to introduce iodine end groups.

In addition to iodine cures sites, other cure sites may also be present, for example Br-containing cure sites or cure sites containing one or more nitrile groups. Br-containing cure sites may be introduced by Br-containing cure-site monomers.

Examples of cure-site comonomers include for instance:
(a) bromo- or iodo-(per)fluoroalkyl-(per)fluorovinylethers, for example including those having the formula:

ZRf—O—CX═CX₂

wherein each X may be the same or different and represents H or F, Z is Br or I, Rf is a C1-C12 (per)fluoroalkylene, optionally containing chlorine and/or ether oxygen atoms. Suitable examples include ZCF₂—O—CF═CF₂, ZCF₂CF₂—O—CF═CF₂, ZCF₂CF₂CF₂—O—CF═CF₂, CF₃CFZCF₂—O—CF═CF₂ or ZCF₂CF₂—O—CF₂CF₂CF₂—O—CF═CF₂ wherein Z represents Br of I; and
(b) bromo- or iodo perfluorolefins such as those having the formula:

Z′—(Rf)r—CX═CX₂

wherein each X independently represents H or F, Z′ is Br or I, Rf is a C₁-C₁₂ perfluoroalkylene, optionally containing chlorine atoms and r is 0 or I; and
(c) non-fluorinated bromo and iodo-olefins such as vinyl bromide, vinyl iodide, 4-bromo-1-butene and 4-iodo-1-butene.

Specific examples include but are not limited to compounds according to (b) wherein X is for example compounds with X being H and Rf being a C1 to C3 perfluoroalkylene. Particular examples include: bromo- or iodo-trifluoroethene, 4-bromo-perfluorobutene-1,4-iodo-perfluorobutene-1, or bromo- or iodo-fluorolefins such as 1-iodo,2,2-difluroroethene, 1-bromo-2,2-difluoroethene, 4-iodo-3,3,4,4,-tetrafluorobutene-1 and 4-bromo-3,3,4,4-tetrafluorobutene-1; 6-iodo-3,3,4,4,5,5,6,6-octafluorohexene-1.

In some embodiments, the cure sites comprise chlorine atoms. Such cure-site monomers include those of the general formula: CX₁X₂═CY₁Y₂where X₁, X₂ are independently H and F; Y₁ is H, F, or Cl; and Y₂ is Cl, a fluoroalkyl group (R_{F}) with at least one Cl substiuent, a fluoroether group (OR_{F}) with at least one Cl substituent, or —CF₂—OR_{F}. The fluoroalkyl group (R_{F}) is typically a partially or fully fluorinated C₁-C₅ alkyl group. Examples of cure-site monomer with chlorine atoms include CF₂═CFCl, CF₂═CF—CF₂Cl, CF₂═CF—O—(CF₂)ₙ—Cl, n=1-4; CH₂═CHCl, CH₂═CCl₂.

Typically, the amount of iodine or bromine or chlorine or their combination in the fluoropolymer is between 0.001 and 5%, preferably between 0.01 and 2.5%, or 0.1 to 1% or 0.2 to 0.6% by weight with respect to the total weight of the fluoropolymer. In one embodiment the curable fluoropolymers contain between 0.001 and 5%, preferably between 0.01 and 2.5%, or 0.1 to 1% more preferably between 0.2 to 0.6% by weight of iodine based on the total weight of the fluoropolymer.

The composition may optionally further comprise a second fluoropolymer that lacks halogen cure sites. The amount of fluoropolymer lacking halogen cure sites is typically less than 50, 45, 40, 35, 30, 25, 20, 15, 10, or 5 wt. % of the total fluoropolymer. Thus, the composition has a sufficient amount of fluoropolymer with halogen cure sites such that adequate crosslinking is achieved.

In one embodiments, the composition further comprises a second (e.g. amorphous) fluoropolymer derived predominantly, or exclusively from two or more perfluorinated comonomers including tetrafluoroethene (TFE) and one or more unsaturated cyclic perfluorinated alkyl ethers, such as 2,2-bistrifluoromethyl-4,5-difluoro-1,3 dioxole. Such fluoropolymers are commercially available as “TEFLON™ AF”. “CYTOP™”, and “HYFLON™”.

In some embodiments, the second fluoropolymer contains nitrile-containing cure sites. When a combination of fluoropolymers with different cure site is utilized the composition may be characterized as a dual curing, containing different cure sites that are reactive to different curing systems.

Although fluoropolymer with halogen cure sites (iodine, bromine, and chlorine) are favored for UV curing, in the case of thermal or e-beam curing; fluoropolymers with nitrile-containing cure cites can alternatively be employed.

Fluoropolymers with nitrile-containing cure sites are known, such as described in U.S. Pat. No. 6,720,360.

Nitrile-containing cure sites may be reactive to other cure systems for example, but not limited to, bisphenol curing systems, peroxide curing systems, triazine curing systems, and especially amine curing systems. Examples of nitrile containing cure site monomers correspond to the following formulae:

CF₂═CF—CF₂—O—Rf—CN;

CF₂═CFO(CF₂)ᵣCN;

CN₂═CFO[CF₂CF(CF₃)O]ₚ(CF₂)ᵥOCF(CF₃)CN;

CF₂═CF[OCF₂CF(CF₃)]ₖO(CF₂)₃CN;

wherein, r represents an integer of 2 to 12; p represents an integer of 0 to 4; k represents 1 or 2; v represents an integer of 0 to 6; u represents an integer of 1 to 6. Rf is a perfluoroalkylene or a bivalent perfluoroether group. Specific examples of nitrile containing fluorinated monomers include but are not limited to perfluoro (8-cyano-5-methyl-3,6-dioxa-1-octene), CF₂═CFO(CF₂)₅CN, and CF₂═CFO(CF₂)₃OCF(CF₃)CN.

In some embodiments, the amount of nitrile-containing cure site comonomer is typically at least 0.5, 1, 1.5, 2, 2.5, 3. 3.5, 4, 4.5 or 5% by weight and typically no greater than 10% by weight; based on the total weight of the fluoropolymer. Suitable curing agents for nitrile cure sites are known in the art and include, but are not limited to (e.g. fluorinated) amidines, amidoximes and others described in WO2008/094758 A1, incorporated herein by reference. Representative curing agents include for example bis-tetraphosphonium perfluoroadipate, methyl sulfone, tetrabutyl phosphonium toluy-hexafluoroisopropoxyde trifluoromethoxy, and tetrafluoropropyl amidine.

In one embodiment, the fluoropolymer with nitrile-containing cure sites can be combined with a peroxide and ethylenically unsaturated compound as curing agents as described in WO 2018/107017. In this embodiments, suitable organic peroxides are those which generate free radicals at curing temperatures. Examples include dialkyl peroxides or bis(dialkyl peroxides), for example. a di-tertiarybutyl peroxide having a tertiary carbon atom attached to the peroxy oxygen. Specific examples include 2,5-dimethyl-2,5-di(tertiarybutylperoxy)hexyne-3 and 2,5-dimethyl-2,5-di(tertiarybutylperoxy)hexane, dicumyl peroxide, dibenzoyl peroxide, tertiarybutyl perbenzoate, alpha,alpha′-bis(t-butylperoxy-diisopropylbenzene), and di[1,3-dimethyl-3-(t-butylperoxy)-butyl]carbonate. Generally, about 1 to 5 parts of peroxide per 100 parts of fluoropolymer may be used.

In other embodiments, the composition is substantially free of fluoropolymer with nitrite- containing cure sites. In this embodiment, the composition is also free of curing agents that react with nitrile groups.

In other embodiments, halogenated chain transfer agents can be utilized to provide terminal cure sites. Chain transfer agents are compounds capable of reacting with the propagating polymer chain and terminating the chain propagation. Examples of chain transfer agents reported. for the production of fluoroelastomers include those having the formula RIₓ, wherein R is an x-valent fluoroalkyl or fluoroalkylene radical having from 1 to 12 carbon atoms, which, may be interrupted by one or more ether oxygens and may also contain chlorine and/or bromine atoms. R may be Rf and Rf may be an x-valent (per)fluoroalkyl or (per)fluoroalkylene radical that may be interrupted once or more than once by an ether oxygen. Examples include alpha-omega diiodo alkanes, alpha-omega diiodo fluoroalkanes, and alpha-omega diiodoperfluoroalkanes, which may contain one or more catenary ether oxygens. “Alpha-omega” denotes that the iodine atoms are at the terminal positions of the molecules. Such compounds may be represented by the general formula X—R—Y with X and Y being I and R being as described above. Specific examples include di-iodomethane, alpha-omega (or 1,4-) diiodobutane, alpha-omega (or 1,3-) diiodopropane, alpha-omega (or 1,5-) diiodopentane, alpha-omega (or 1,6-) diiodohexane and 1,2-diiodoperfluoroethane. Other examples include fluorinated di-iodo ether compounds of the following formula:

R_{f}—CF(I)—(CX₂)ₙ—(CX₂CXR)ₘ—O—R″f—Oₖ—(CXR′CX₂)ₚ—(CX₂)_{q}—CF(I)—R′_{f}

wherein X is independently selected from F, H, and Cl; R_{f} and R′_{f} are independently selected from F and a monovalent perfluoroalkane having 1-3 carbons; R is F, or a partially fluorinated or perfluorinated alkane comprising 1-3 carbons; R″_{f} is a divalent fluoroalkylene having 1-5 carbons or a divalent fluorinated alkylene ether having 1-8 carbons and at least one ether linkage; k is 0 or 1; and n, m, and p are independently selected from an integer from 0-5, wherein, n plus m at least 1 and p plus q are at least 1.

The fluoropolymers may or may not contain units derived from at least one modifying monomer. The modifying monomers may introduce branching sites into the polymer architecture. Typically, the modifying monomers are bisolefins, bisolefinic ethers or polyethers. The bisolefins and bisolefinic (poly)ethers may be perfluorinated, partially fluorinated or non-fluorinated. Preferably they are perfluorinated. Suitable perfluorinated bisolefinic ethers include those represented by the general formula:

CF₂═CF—(CF₂)ₙ—O—(Rf)—O—(CF₂)ₘ—CF═CF₂

wherein n and m are independent from each other either 1 or 0 and wherein Rf represents a perfluorinated linear or branched, cyclic or acyclic aliphatic or aromatic hydrocarbon residue that may be interrupted by one or more oxygen atoms and comprising up to 30 carbon atoms. A particular suitable perfluorinated bisolefinic ether is a di-vinylether represented by the formula:

CF₂═CF—O—(CF₂)ₙ—O—CF═CF₂

wherein n is an integer between 1 and 10, preferably 2 to 6, e.g. n may be 1, 2, 3, 4, 5, 6 or 7. More preferably, n represents an uneven integer, for example 1, 3, 5 or 7.

Further specific examples include bisolefinic ethers according the general formula

CF₂═CF—(CF₂) ₙ—O—(CF₂)ₚ—O—(CF₂)ₘ—CF═CF₂

wherein n and in are independently either 1 or 0 and p is an integer from 1 to 10 or 2 to 6. For example, n may be selected to represent 1, 2, 3, 4, 5, 6 or 7, preferably, 1, 3, 5 or 7.

Further suitable perfluorinated bisolefinic ethers can be represented by the formula

CF₂═CF—(CF₂)ₚ—O—(R_{af}O)ₙ(R_{bf}O)ₘ—(CF₂)q—CF═CF₂

wherein R_{af} and R_{bf} are different linear or branched perfluoroalkylene groups of 1-10 carbon atoms, in particular, 2 to 6 carbon atoms, and which may or may not be interrupted by one or more oxygen atoms. R_{af} and/or R_{bf} may also be perfluorinated phenyl or substituted phenyl groups; n is an integer between 1 and 10 and m is an integer between 0 and 10, preferably m is 0. Further, p and q are independently 1 or 0.

In another embodiment, the perfluorinated bisolefinic ethers can be represented by the formula just described wherein in, n, and p are zero and q is 1-4.

Modifying monomers can be prepared by methods known in the art and are commercially available, for example, from Anles Ltd., St, Petersburg, Russia.

Preferably, the modifiers are not used or only used in low amounts. Typical amounts include from 0 to 5%, or from 0 to 1.4% by weight based on the total weight of the fluoropolymer. Modifiers may be present, for example, in amounts from about 0.1% to about 1.2% or from about 0.3% to about 0.8% by weight based on the total weight of fluoropolymer. Combinations of modifiers may also be used.

The fluoropolymers may contain partially fluorinated or non-fluorinated comonomers and combinations thereof, although this is not preferred. Typical partially fluorinated comonomers include but are not limited to 1,1-difluoroethene (vinylidenefluoride, VDF) and vinyl fluoride (VF) or trifluorochloroethene or trichlorofluoroethene. Examples of non-fluorinated comonomers include but are not limited to ethene and propene. The amount of units derived from these comonomers include from 0 to 8% by weight based on the total weight of the fluoropolymer. In some embodiments, the concentration of such comonomer is no greater than 7, 6, 5, 4, 3, 2, or 1% by weight based on the total weight of the fluoropolymer.

In a preferred embodiment, the curable fluoropolymer is a perfluoroelastomer that comprises repeating units (exclusively) derived from the perfluorinated comonomers but may contain units derived from cure-site monomers and modifying monomers if desired. The cure-site monomers and modifying monomers may be partially fluorinated, not fluorinated or perfluorinated, and preferably are perfluorinated. The perfluoroelastomers may contain from 69 to 73, 74, or 75% fluorine by weight (based on the total amount of perfluoroelastomer). The fluorine content may be achieved by selecting the comonomers and their amounts accordingly.

Such highly-fluorinated amorphous fluoropolymers typically do not dissolve to the extent of at least 1 wt. %, at room temperature and standard pressure, in a hydrogen-containing organic liquid (e.g., it does not dissolve in any of methyl ethyl ketone (“MEK”), tetrahydrofuran (“THF”), ethyl acetate or N-methyl pyrrolidinone (“NMP”)).

The fluoropolymers can be prepared by methods known in the art, such as bulk, suspension, solution or aqueous emulsion polymerization. Various emulsifiers can be used as described in the art, including for example 3H-perfluoro-3-[(3-methoxy-propoxy)propanoic acid. For example, the polymerization process can be carried out by free radical polymerization of the monomers alone or as solutions, emulsions, or dispersions in an organic solvent or water. Seeded. polymerizations may or may not be used. Curable fluoroelastomers that can be used also include commercially available fluoroelastomers, in particular perfluoroelastomers.

The fluoropolymers may have a monomodal or bi-modal or multi-modal weight distribution. The fluoropolymers may or may not have a core-shell structure. Core-shell polymers are polymers where towards the end of the polymerization, typically after at least 50% by mole of the comonomers are consumed, the comonomer composition or the ratio of the comonomers or the reaction speed is altered to create a shell of different composition.

The fluorine content of the fluoropolymer is typically at least 60, 65, 66, 67, 68, 69, or 70 wt. % of the fluoropolymer and typically no greater than 76, 75, 74, or 73 wt. %.

The fluoropolymer compositions described herein may contain one or more ethylenically unsaturated curing agents. The ethylenically unsaturated curing agents are typically present in an amount of at least 1, 1.5, or 2 wt. % based on the total weight of the fluoropolymer. For compositions having a lower amount of crosslinking, the ethylenically unsaturated curing agents may be present at a lower amount such as at least 0.005, 0.1, 0.2, 0.3, 0.5 wt. %. The maximum amount of ethylenically unsaturated curing agents is typically no greater than 10, 9, 8, 7, 6, or 5 wt. % based on the total weight of the fluoropolymer.

The ethylenically unsaturated group(s) of the curing agent are typically (meth)acryl including (meth)acrylate RCH═CHCOO— and (meth)acrylamide RCH═CHCONH—, wherein R is methyl of hydrogen; alkenyl including vinyl (CH₂═CH—); or alkynyl.

Useful multi-(meth)acrylate curing agents include

(a) di(meth)acryl containing monomers such as 1,3-butylene glycol diacrylate, 1,4-butanediol diacrylate, 1,6-hexanediol diacrylate, 1,6-hexanediol monoacrylate monomethacrylate, ethylene glycol diacrylate, alkoxylated aliphatic diacrylate, alkoxylated cyclohexane dimethanol diacrylate, alkoxylated hexanediol diacrylate, alkoxylated neopentyl glycol diacrylate, caprolactone modified neopentylglycol hydroxypivalate diacrylate, caprolactone modified neopentylglycol hydroxypivalate diacrylate, cyclohexanedimethanol diacrylate, diethylene glycol diacrylate, dipropylene glycol diacrylate, ethoxylated bisphenol A diacrylate, hydroxypivalaldehyde modified trimethylolpropane diacrylate, neopentyl glycol diacrylate; polyethylene glycol diacrylate, propoxylated neopentyl glycol diacrylate, tetraethylene glycol diacrylate, tricyclodecanedimethanol diacrylate, triethylene glycol diacrylate, tripropylene glycol diacrylate;

(b) tri(meth)acryl containing monomers such as glycerol triacrylate, trimethylolpropane triacrylate, ethoxylated triacrylates (e.g., ethoxylated trimethylolpropane triacrylate), propoxylated triacrylates (e.g., propoxylated glyceryl triacrylate, propoxylated trimethylolpropane triacrylate), trimethylolpropane triacrylate, tris(2-hydroxyethyl)isocyanurate triacrylate,

(c) higher functionality (meth)acryl containin monomer such as ditrimethylolpropane tetraacrylate, dipentaervthritol pentaacrylate, pentaerythritol triacrylate, ethoxylated pentaerythritol tetraacrylate, and caprolactone modified dipentaerythritol hexaacrylate.

In some embodiments, the ethylenically unsaturated curing agent comprises at least two or three ethylenically unsaturated groups. The maximum number of ethylenically unsaturated groups is typically 3, 4, 5, or 6. In this embodiment, the ethylenically unsaturated groups are preferably alkenyl groups. Thus, the composition in some embodiments, the composition is substantially free of (meth)acrylate groups.

The ethylenically unsaturated curing agent may be linear, branched, or comprise a cyclic group. The ethylenically unsaturated curing agent may be aliphatic or aromatic. Examples of useful ethylenically unsaturated curing agents include triallyl cyanurate; triallyl isocyanurate, triallyl trimellitate; tri(methylallyl)isocyanurate; tris(diallyiamine)-s-triazine; triallyl phosphite; (N,N′)-diallyl acrylamide; hexaallyl phosphoramide, (N,N,N,N)-tetraalkyl tetraphthalamide; (N,N,N′,N-tetraallylinalonamide, trivinyl isocyanurate; N,N′-m-phenylenebismaleimide; diallyl-phthalate and tri(5-norbornene-2-methylene)cyanurate. In some embodiments, the ethylenically unsaturated curing agent is heterocyclic such as in the case of triallyl isocyanurate (TAIC).

In some embodiments, the ethylenically unsaturated curing agent comprises a silicone-containing moiety such as silane or siloxane. When the curing agent includes silicone-containing moiety, the curing agent can also promote adhesion of the fluoropolymer to a substrate.

Suitable ethylenically unsaturated curing agent that comprise silicone-containing moieties include for example diallydimethylsilane; and 1,3-divinyltetramethyl disiloxane.

In some embodiment, the ethylenically unsaturated curing agent comprises at least one ethylenically unsaturated group and at least one alkoxy silane group. Suitable curing agents include for example (meth)acryloy alkoxy silanes such as 3-(methacryloxy)propyltrimethoxysilane, 3-(methacryloxy)propylmethyldimethoxysilane, 3-(acryloyloxypropyl)methyl dimethoxysilane, 3-(methacryloyloxy)propyldimethylmethoxysilane, and 3-(acryloxypropyl) dimethylmethoxysilane. In some embodiments, the amount of (meth)acryloy alkoxy silanes is at least 2, 3, 4, or 5 wt. % to achieve a highly crosslinked fluoropolymer.

Suitable alkenyl alkoxy silanes include vinyldimethylethoxysilane, vinylmethyldiacetoxysilane, vinylinethyldiethoxysilane, vinvltriacetoxysilane, vinyltriethoxysilane, vinyltriisopropoxysilane, vinyltrimethoxysilane, vinyltriphenoxysilane, vinyltri-t-butoxysilane, vinyltris-isobutoxysilane, vinyltriisopropenoxysilane, vinyltris(2-methoxyethoxy)silane, and allyltriethoxysilane.

In some embodiments, the ethylenically unsaturated curing agent may have the general formula

X¹—L¹—SiRₘ(OR¹)₃₋ₘ;

wherein X¹ is an ethylenically unsaturated group, such as (meth)acryl or vinyl;
L ¹ is an organic divalent linking group having 1 to 12 carbon atoms;
R is independently C₁-C₄ alkyl and most typically methyl or ethyl;
R¹ is independently H or C₁-C₄ alkyl and most typically methyl or ethyl; and m ranges from 0 to 2.

In typical embodiments, L¹ is an alkylene group. In some embodiments, L¹ is an alkylene group having 1, 2 or 3 carbon atoms. in other embodiments, L¹ comprises or consists of an aromatic group such as phenyl or (e.g. C₁-C₄) alkyl phenyl.

The composition may comprise a single ethylenically unsaturated curing agent as just described or combinations of ethylenically unsaturated curing agents.

The composition described herein further comprises an electron donor group or precursor thereof. The electron donor group may be present on the same compound such as in the case of an aminoalkene or vinylaniline or the electron donor group may be present as a separate compound.

The fluoropolymer and/or the curing agent(s) comprise a chromophore, i.e. an atom or group that absorbs light at a specified frequency. In some embodiments, the fluororpolymer and/or curing agent may not have sufficient absorbance independently, but have sufficient absorbance in combination with each other.

In some embodiments, the fluoropolymer, curing agent(s), or combination, thereof have an absorbance of at least 0.1, 0.2, 0.3, 0.4, 0.5, 0.6, 0.7, 0.8, 0.9, or 1.0 at wavelength ranging from 190 nm to 400 nm. In some embodiments, such absorbance is at wavlength of at least 200 nm, 210 nm, 220 nm, 230 nm or 240 nm. In some embodiments, such absorbance is at wavlength of no greater than 350, 340, 330, 320, 310 nm, or 290 nm. In other embodiments, the fluoropolymer, curing agent(s), or combination, thereof have an absorbance of at least 0.1, 0.2, 0.3, 0.4, 0.5, 0.6, 0.7, 0.8, 0.9, or 1.0 at wavelength ranging from 150 nm to 200 nm.

Without intending to be bound by theory, it is surmised that upon exposure to suitable wavelengths and intensities of actinic (e.g. UV) radiation the halogen atoms of the cure sites of the fluoropolymer become excited and ionize. The ionized halogen atoms react with the electron donor group rendering protonated cure sites in place of the former halogen atoms. Such protonated cure site covalently bond with the ethylenically unsaturated group(s) of the curing agent.

Although other electon donor groups could he utilized, the compound comprising an electron donor group is typically an amine ; or precursor thereof. Suitable amines include primary amine, secondary amines, teritiary amines, and combinations thereof The amine may be aliphatic or aromatic. Amine compounds can also be utilized to provide a crosslinked fluoropolymer layer by (e.g. thermally) curing a fluoropolymer with (e.g. nitrile) cure sites utilizing an amine cuing agent.

Illustrative amine compounds include diamino hexane, N,N,N′,N′-tetramethyl-1,4-butane (TMDAB); N,N-dimethyl aniline; triethylenetetramine; and diethylenetriamine. In some embodiments, the amine groups are spaced apart by an alkylene group having at least 3, 4, 5, or 6 (e.g. carbons) atoms. Typically, the number of (e.g. carbon) atoms is no greater than 12. When the amine compound has an insufficient chain length, it can be a less effective electon donor group. The alkylene group can optionally comprise subsituents, such as siloxane, provided the compound is an electron donor or precursor thereof.

In some embodiments, the electron donor compound may be characterized as an electron donor precursor meaning that when the compound is initially combined with the fluoropolymer it is not an electron donor. However, the precursor compound decomposes or otherwise reacts to form an (e.g. amine) electron donor prior to or during curing.

Electron donor precursors include nitrogen-containing nucleophilic compounds such as heterocyclic secondary amines; guanidines; compounds which decompose in-situ at a temperature between 40° C. and 330° C. to produce a guanidine; compounds which decompose in-situ at a temperature between 40° C. and 330° C. to produce a primary or secondary amine; nucleophilic compounds of the formula R₁—NH—R₂, wherein R₁ is H—, a C₁-C₁₀ aliphatic hydrocarbon group, or an aryl group having hydrogen atoms in the alpha positions, R₂ is a C₁-C₁₀ aliphatic hydrocarbon group, an aryl group having hydrogen atoms in the alpha positions, —CONHR₃, —NHCO₂R₃, or —OH′, and R₃ is a C₁-C₁₀ aliphatic hydrocarbon group; and substituted amidines of the formula HN═CR₄NR₅R₆, wherein R₄, R₅, R₆ are independently H—, alkyl or aryl groups and wherein at least one of R₄, R₅ and Re is not H—.

As used herein, “heterocyclic secondary amine” refers to aromatic or aliphatic cyclic compound having at least one secondary amine nitrogen contained within the ring. Such compounds include, for example, pyrrole, imidazole, pyrazole, 3-pyrroline, and pyrrolidine.

Guanidines are compounds derived from guanidine, i.e. compounds which contain the radical, —NHCNHNH—, such as, but not limited to, diphenylguanidine, diphenylguanidine acetate, aminobutylguanidine, biguanidine, isopentylguanidine, di-o-tolylguanidine, o-tolylbiguanide, and triphenylgluanidine.

Other compounds that decompose in-situ at a temperature between 40° C. and 330° C. to produce either a primary or secondary amine include, but are not limited to, di- or poly-substituted ureas (e.g. 1,3-dimethyl urea); N-alkyl or -dialkyl carbamates (e.g. N-(tert-butyloxycarbonyl)propylamine); di- or poly-substituted thioureas (e.g. 1,3-dimethyl-thiourea); aldehyde-amine condensation products (e.g. 1,3,5-trimethylhexahydro-1,3,5-triazine); phthalamide derivatives (e.g. N,N′-dimethylphthalamide); and amino acids.

When thermally activated electron donor precursor compounds are utilized as just described, the composition is typically heated prior to and/or during curing.

Other types of amine electron donor include bis(aminophenols) and bis(aminothiophenols) of the formulas

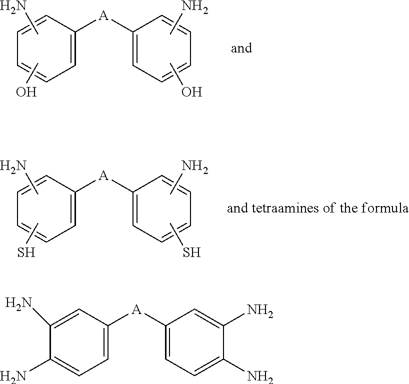

where A is SO₂, O, CO, alkyl of 1-6 carbon atoms, perfluoroalkyl of 1-10 carbon atoms, or a carbon-carbon bond linking the two aromatic rings. The amino and hydroxyl groups in the above formulas are interchangeably in the meta and para positions with respect to group A.

In some embodiments, the amine electron donor compound is an aziridine compound. In some embodiments, the aziridine compound comprises at least two aziridine groups. The aziridine compound may comprise 3, 4, 5, 6, or greater than 6 aziridine groups. The aziridine compound may be represented by the following structure:

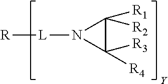

wherein R is a core moiety having a valency of Y;
L is a bond, divalent atom, or divalent linking group;
R₁, R₂, R₃, and R₄ are independently hydrogen or a C₁-C₄ alkyl (e.g. methyl); and Y is typically 2, 3, or greater.

In some embodiments, R is —SO₂—. In some embodiments, R-L is a residue of a multi(meth)acrylate compound. In some embodiments L is a C₁C₄ alkylene, optionally substituted with one or more (e.g. contiguous or pendant) oxygen atoms thereby forming ether or ester linkages. In typical embodiments, R₁ is methyl and R₂, R₃, and R₄ are hydrogen.

Representative aziridine compounds include trimethylolpropane tri-[beta-(N-aziridinyl)-propionate], 2,2-bishydeoxymethyl butanoltris[-(1-aziridine) propionate], 1-(aziridin-2-yl)-2-oxabut-3-ene; and 4-(aziridin-2-yl)-but-1-ene; and 5-(aziridin-2-yl)-pent-1-ene.

In some embodiments, a polyaziridine compound can be prepared by reacting divinyl sulfone with alkylene (e.g. ethylene) imine, such as described in U.S. Pat. No. 3,235,544 (Christena). On representative compound is di(2-propyleniminoethyl)sulfone, as depicted as follows:

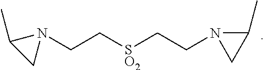

The above described polyaziridine compounds comprise at least two aziridine groups at the time the compound is added to the coating composition. In other embodiments, the polyaziridine compound does not comprise two aziridine groups at the time the compound is added to the composition, yet forms a polyaziridine in-situ. For example, compounds comprising a single aziridine group and a single (meth)acrylate group can thrill a dimer or oligomerize by reaction of the (meth)acrylate groups thereby forming a polyazirdine (i.e. diaziridine) compound.

In some embodiments, the composition comprises an electron donor compound comprising at least one (e.g. primary, secondary tertiary) amine group and at least one organosilane alkoxy silane) group. Such compounds can improve bonding an independently crosslink the fluoroelastomers described herein, thereby providing a second fluoropolymer crosslinking mechanism. By use of ethylenically unsaturated curing agents in combination with amino-substituted organosilanes, highly crosslinked fluoropolymers can be provided utilizing lower concentrations of curing agents and electron donor compounds.

In some embodiments, the amine may be characterized as an amino-substituted organosilane ester or ester equivalent that bear on the silicon atom at least one, and preferably 2 or 3 ester or ester equivalent groups. Ester equivalents are known to those skilled in the art and include compounds such as silane amides (RNR′Si), silane alkanoates (RC(O)OSi), Si—O—Si, SiN(R)—Si, SiSR and RCONR′Si compounds that are thermally and/or catalytically displaceable by R″OH. R and R′ are independently chosen and can include hydrogen, alkyl, arylalkyl, alkenyl, alkynyl, cycloalkyl and substituted analogs such as alkoxyalkyl, aminoalkyl, and alkylaminoalkyl. R″ may be the same as R and R′, except it may not be H. These ester equivalents may also be cyclic such as those derived from ethylene glycol, ethanolamine, ethylenediamine (e.g. N-[3-(trimethoxylsilyl)propyl]ethylenediamine) and their amides.

Another such cyclic example of an ester equivalent is

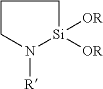

In this cyclic example R′ is as defined in the preceding sentence, except that it may not be aryl. 3-aminopropyl alkoxysilanes are well known to cyclize upon heating, and these RNHSi compounds would be useful in this invention. Preferably the amino-substituted organosilane ester or ester equivalent has ester groups such as methoxy that are easily volatilized as methanol. The amino-substituted organosilane must have at least one ester equivalent; for example, it may be a trialkoxysilane.

For example, the amino-substituted organosilane may have the formula.

(Z₂N—L—SiX′X″X′″), wherein

Z is hydrogen, alkyl, or substituted aryl or alkyl including amino-substituted alkyl; and L is a divalent straight chain C1-12 alkylene or may comprise a C3-8 cycloalkylene, 3-8 membered ring heterocycloalkylene, C2-12 alkenylene, C4-8 cycloalkenylene, 3-8 membered ring heterocycloalkenylene or heteroarylene unit; and each of X′, X″ and X′″ is a C1-18 alkyl, halogen, C1-8 alkoxy, C1-8 alkylcarbonyloxy, or amino group, with the proviso that at least one of X′, X″, and X′″ is a labile group. Further, any two or all of X′, X′″ and X′″ may be joined through a covalent bond. The amino group may be an alkylamino group.

L may be divalent aromatic or may be interrupted by one or more divalent aromatic groups or heteroatomic groups. The aromatic group may include a heteroaromatic. The heteroatom is preferably nitrogen, sulfur or oxygen. L is optionally substituted with C1-4 alkyl; C2-4 alkenyl, C2-4 alkynyl, C1-4 alkoxy, amino, C3-6 cycloalkyl, 3-6 membered heterocycloalkyl, monocyclic aryl, 5-6 membered ring heteroaryl, C1-4 alkylcarbonyloxy, C1-4 alkyloxycarbonyl, C1-4 alkylcarbonyl, formyl, C1-4 alkylcarbonylamino, or C1-4 aminocarbonyl, L is further optionally interrupted by —O—, —S—, —N(Rc)—, —N(Rc)—C(O)—, —N(Rc)—C(O)—O—, —O—C(O)—N(Rc)—, —N(Rc)—C(O)—N(Rd)-, —O—C(O)—, —C(O)—, or —O—C(O)—O—. Each of Rc and Rd, independently, is hydrogen, alkyl alkenyl, alkynyl, alkoxyalkyl, aminoalkyl (primary, secondary or tertiary), or haloalkyl.

Examples of amino-substituted organosilanes include 3-aminopropyltrimethoxysilane (SILQUEST A-1110), 3-aminopropyltriethoxysilane (SILQUEST A-1100); bis(3-trimethoxysilylpropy)amine, bis(3-triethoxysilylpropy)amine, bis(3-trimethoxysilylpropy)n-methylamine, 3-(2-aminoethyl)aminopropyltrimethoxysilane (SILQUEST A-1120), SILQUEST A-1130, (aminoethylaminomethyl)phenethyltrimethoxysilane, (aminoethylaminomethyl)-phenethyltriethoxysilane, N-(2-aminoethyl)-3-aminopropylmethyldimethoxysilane (SILQUEST A-2120), his-(.gamma.-triethoxysilylpropyl)amine (SILQUEST A-1170), N-(2-aminoethyl)-3-aminopropyltributoxysilane, 6-(aminohexylaminopropyl)trimethoxysilane, 4-aminobutyltrimethoxysilane, 4-aminobutyltriethoxysilane, p-(2-aminoethyl)phenyltrimethoxysilane, 3-aminopropyltris(methoxyethoxyethoxy)silane, 3-aminopropylmethyldiethoxy-silane, oligomeric aminosilanes such as DYNASYLAN 1146, 3-(N-methylamino)propyltrimethoxysilane, N-(2-aminoethyl)-3-aminopropylmethyldimethoxysilane, N-(2-aminoethyl)-3-aminopropylmethyldiethoxysilane, N-(2-aminoethyl)-3-aminopropyltrimethoxysilane, N-(2-aminoethyl)-3-aminopropyltriethoxysilane, 3-aminopropylmethyldiethoxysilane, 3-aminopropylmethyldimethoxysilane, 3-aminopropyldimethylmethoxysilane, 3-aminopropyldimethylethoxysilane, and the following cyclic compounds:

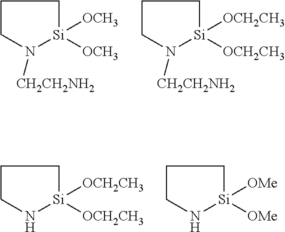

A bis-silyl urea [RO)₃Si(CH₂)NR]₂C═O is another example of an amino-substituted organosilane ester or ester equivalent.

In some embodiments, the curing agent may comprise an amino group having latent functionality. One example of such curing agent is a blocked amine group, such as

R³—N═C(R¹)(R²)

wherein R¹ and R² are independently selected from a linear or branched alkyl group comprising 1 to 6 carbon atoms. In typical embodiments R1 is methyl, and R² a linear or branched alkyl group comprising at least 2, 3, 4, 5, or 6 carbon atoms. R³ is typically an organic group (e.g. having a molecular weight less than 500, 450, 400, 350, 300, or 250 g/mole).

The blocked amine can be activated by moisture provided by water adsorbed on the surface of the substrate being coated or from humidity. Deblocking begins in minutes and is generally complete within a few (e.g. two) hours. During deblocking the —N═C(R¹)(R²) group is converted to —NH₂ that can then react with the (e.g. nitrile cure sites) of the fluoropolymer.

In some embodiments, the curing agent comprises a blocked amine group and an alkoxy silane group. Such blocked amine curing agent can be characterized by the following general formula:

(R⁴O)₃—Si—(CH₂)ₘ—N═C(R1)(R2)

wherein R¹ and R² are independently selected from a linear or branched alkyl group comprising 1 to 6 carbon atoms as previously described. R¹ is independently selected from a linear or branched alkyl group comprising 1 to 6 carbon atoms, m is an integer from 1 to 4, and each R⁴ is independently a C1 or C2 alkyl group.

One illustrative curing agent comprising a blocked amine group and an alkoxy silane group is N-(1,3-dimethylbutylidene)aminopropyl-triethoxysilane, depicted as follows:

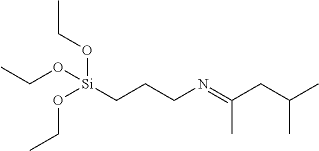 [SMILES: CCO[Si](CCC/N=C(\C)CC(C)C)(OCC)OCC]

Such curing agent is available from Gelest and from 3M as “3M™ Dynamer™ Rubber Curative RC5125”. Blocked amines are additional examples of electron donor precursors.

In some embodiments, the amine curing agent comprises an aziridine group and an alkoxy silane group. Such compounds are known for examples from U.S. Pat. No. 3,243,429; incorporated herein 20 by reference. Aziridine alkoxy silane compounds may have the general structure:

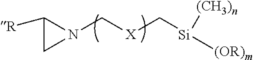

wherein R″ is hydrogen or a C₁-C₄ alkyl (e.g. methyl);
X is a bond, a divalent atom, or a divalent linking group;
n is 0, 1 or 2;
m is 1, 2, or 3; and
and the sum or n +m is 3.

One representative compound is 3-(2-methylaziridinyl) ethylcarboxylpropyltriethoxysilane.

Various other suitable aziridine crosslinkers are known, such as described in WO2014/075246; published May 22, 2014, incorporated herein by reference; and “NEW GENERATION OF MULTIFUNCTIONAL CROSSLINKERS,” (See https://www.pstc.org/files/public/Milker00.pdf.

The composition comprises a single (e.g. amine) electron donor compound or a combination of amine electron donor compounds may be present.

The amount of (e.g. amine) electron donor compound is typically at least 0.01, 0.02, 0.03, 0.04, 0.05, 0.06, 0.07, 0.08, 0,09, 0,1, 0.2, 0.3, 0.4, or 0.5% by weight solids (i.e, excluding the solvent of the coating composition). In some embodiments, the amount of (e.g. amine) electron donor compound is no greater than 5, 4.5, 4. 3.5, or 3% by weight solids.

In some embodiments, the fluoropolymer composition further comprises an alkoxy silane compound that lacks amine functionality. In some embodiments, such alkoxy silanes may be characterized as “non-functional” having the chemical formula:

R²Si(OR¹)ₘ

wherein R¹ is independently alkyl as previously described; R² is independently hydrogen, alkyl, aryl, alkaryl, or OR¹, and in ranges from 1 to 3, and is typically 2 or 3 as previously described.

Suitable alkoxy silanes of the formula R²Si(OR¹)ₘ include, but are not limited to tetra-, tri- or dialkoxy silanes, and any combinations or mixtures thereof. Representative alkoxy silanes include propyltrimethoxysilane, propyltriethoxysilane, butyltrimethoxysilane, butyltriethoxysilane, pentyltrimethoxysilane, pentyltriethoxysilane, heptyltrimethoxysilane, heptyltriethoxysilane, octyltrimethoxysilane, octylthethoxysilane, dodecylisimethoxysilane, dodecyltriethoxysilane, hexadecyltrimethoxysilane, hexadecyltriethoxysilane, octadecyltrimethoxysilane, octadecyltriethoxysilane, phenyltrimethoxysilane, phenyltriethoxysilane dimethyldimethoxysilane and dimethyldiethoxysilane.

Preferably, the alkyl group(s) of the alkoxy silanes comprises from 1 to 6, more preferably 1 to 4 carbon atoms. Preferred alkoxysilanes for use herein are selected from the group consisting of tetra methoxysilane, tetra ethoxysilane, methyl triethoxysilane, dimethyldiethoxysilane, and any mixtures thereof. A preferred alkoxysilane for use herein comprises tetraethoxysilane (TEOS). The alkoxy silane lacking organofunctional groups utilized in the method of making the coating composition may be partially hydrolyzed, such as in the case of partially hydrolyzed tetramethoxysilane (TMOS) available from Mitsuibishi Chemical Company under the trade designation “MS-51”.

When present, the amount of alkoxy silane compound that lacks (amine/electron donor) functionality (e.g. TESO is typically at least 0.01, 0.02, 0.03, 0.04, 0.05, 0.06, 0.07, 0.08, 0.09, 0.1, 0.2, 0.3, 0.4, or 0.5% by weight solids (i.e. excluding the solvent of the coating composition). In some embodiments, the amount of alkoxy silane compound that lacks functionality is no greater than 5, 4.5, 4. 3.5, or 3% by weight solids.

In some embodiments, the composition described herein comprises a (e.g. UV) curing system comprising an ethylenically unsaturated compound in combination with an electron donor compound, such as an amine, in the absence of an organic peroxide. Organic peroxides are electron acceptors and thus would compete with the ionized halogen atom, thereby reducing crosslinking of the fluoropolymer. In some embodiments, the composition is also substantially free of other electron acceptors that would reduce crosslinking.

In other embodiments, an amino organosilane ester compound or ester equivalent can he utilized in the absence of an ethylenically unsaturated compound to (e.g. UV) cure and/or thermally cure the fluoropolymer, as described in PCT/US2019/036460, incorporated herein by reference.

The fluoropolymer (coating solution) compositions comprises at least one solvent. The solvent is capable of dissolving the fluoropolymer. The solvent is typically present in an amount of at least 25% by weight based on the total weight of the coating solution composition. In some embodiments, the solvent is present in an amount of at least 30, 35, 40, 45, 50, 55, 60, 65, 70, 75, 80, 85, 90, 95% or greater based on the total weight of the coating solution composition.

The fluoropolymer (coating solution) composition typically comprises at least 0.01, 0.02, 0.03, 0.03, 0.04, 0.04, 0.05, 0.06, 0.7, 0.8. 0.9 or 1% by weight of fluoropolymer, based on the weight of the total coating solution composition. In some embodiments, the fluoropolymer coating solution composition comprises at least 2, 3, 4, or 5% by weight of fluoropolymer. In some embodiments, the fluoropolymer coating solution composition comprises at least 6, 7, 8, 9 or 10% by weight of fluoropolymer. The fluoropolymer coating solution composition typically comprises no greater than 50, 45, 40, 35, 30, 25, or 20% by weight of fluoropolymer, based on the weight of the total coating solution composition.

Optimum amounts of solvent and fluoropolymers may depend on the final application and may vary. For example, to provide thin coatings, very dilute solutions of fluoropolymer in the solvent may be desired, for example amounts of from 0.01% by weight to 5% by weight of fluoropolymer. Also for application by spray coating composition of low viscosity may be preferred over solutions with high viscosity. The concentration of fluoropolymer in the solution affects the viscosity and may be adjusted accordingly. An advantage of the present disclosure is that also solutions with high concentrations of fluoropolymer can be prepared that still provide clear liquid composition of low viscosity.

In some embodiments, the fluoropolymer coating solution compositions may be liquids. The liquids may have, for example, a viscosity of less than 2,000 mPas at room temperature (20° C. +/−2° C). In other embodiments, the fluoropolymer coating solution compositions are pastes. The pastes may have, for example, a viscosity of from 2,000 to 100,000 mPas at room temperature (20° C. +/−2° C.).

The solvent is a liquid at ambient conditions and typically has a boiling point of greater than 50° C. Preferably, the solvent has a boiling point below 200° C. so that it can be easily removed. In some embodiments, the solvent has a boiling point below 190, 180, 170, 160, 150, 140, 130, 120, 110, or 100° C.

The solvent is partially fluorinated or perfluorinated. Thus, the solvent is non-aqueous. Various partially fluorinated or perfluorinated solvents are known including perfluorocarbons (PFCs), hydrochlorofluorocarbons (HCFCs), perfluoropolyethers (PFPEs), and hydrofluorocarbons (HFCs), as well as fluorinated ketones and fluorinated alkyl amines.

In some embodiments, the solvent has a global warming potential (GWP, 100 year ITH) of less than 1000, 900, 800, 700, 600, 500, 400, 300, 200 or 100. The GWP is typically greater than 0 and may be at least 10, 20, 30, 40, 50, 60, 70, or 80.

As used herein, GWP is a relative measure of the global warming potential of a compound based on the structure of the compound. The GWP of a compound, as defined by the Intergovernmental Panel on Climate Change (IPCC) in 1990 and updated in subsequent reports, is calculated as the warming due to the release of 1 kilogram of a compound relative to the warming due to the release of 1 kilogram of CO₂ over a specified integration time horizon (ITH).

$${GWP}_{x} = \frac{{{\int }_{0}}^{ITH} {F}_{x} {C}_{xo} exp ( - t / {τ}_{x} ) dt}{{{\int }_{0}}^{ITH} {F}_{{CO}_{2}} {C}_{{CO}_{2}} ( t ) dt}$$

where F is the radiative forcing per unit mass of a compound (the change in the flux of radiation through the atmosphere due to the IR absorbance of that compound), C₀ is the atmospheric concentration of a compound at initial time, τ is the atmospheric lifetime of a compound, t is time, and x is the compound of interest.

In some embodiments, the solvent comprises a partially fluorinated ether or a partially fluorinated polyether. The partially fluorinated ether or polyether may be linear, cyclic or branched. Preferably, it is branched. Preferably it comprises a non-fluorinated alkyl group and a perfluorinated alkyl group and more preferably, the perfluorinated alkyl group is branched.

In one embodiment, the partially fluorinated ether or polyether solvent corresponds to the formula:

R_{f}—O—R

wherein Rf is a perfluorinated or partially fluorinated alkyl or (poly)ether group and R is a non-fluorinated or partially fluorinated alkyl group. Typically, Rf may have from 1 to 12 carbon atoms. Rf may be a primary, secondary or tertiary fluorinated or perfluorinated alkyl residue. This means, when Rf is a primary alkyl residue the carbon atom linked to the ether atoms contains two fluorine atoms and is bonded to another carbon atom of the fluorinated or perfluorinated alkyl chain. In such case Rf would correspond to R_{f}¹—CF₂— and the polyether can be described by the general formula: R_{f}¹—CF₂—O—R.

When Rf is a secondary alkyl residue, the carbon atom linked to the ether atom is also linked to one fluorine atoms and to two carbon atoms of partially and/or perfluorinated alkyl chains and Rf corresponds to (R_{f}²R_{f}³)CF—. The polyether would correspond to (R_{f}²R_{f}³)CF—O—R.

When Rf is a tertiary alkyl residue the carbon atom linked to the ether atom is also linked to three carbon atoms of three partially and/or perfluorinated alkyl chains and Rf corresponds to (R_{f}⁴R_{f}⁵R_{f}⁶)—C—. The polyether then corresponds to (R_{f}⁴R_{f}⁵R_{f}⁶)—C—OR. R_{f}¹; R_{f}²; R_{f}³; R_{f}⁴; R_{f}⁵; R_{f}⁶ correspond to the definition of Rf and are a perfluorinated or partially fluorinated alkyl group that may be interrupted once or more than once by an ether oxygen. They may be linear or branched or cyclic. Also a combination of polyethers may be used and also a combination of primary, secondary and/or tertiary alkyl residues may be used.

An example of a solvent comprising a partially fluorinated alkyl group includes C₃F₇OCHFCF₃ (CAS No. 3330-15-2).

An example of a solvent wherein Rf comprises a perfluorinated (poly)ether is C₃F₇OCF(CF₃)CF₂OCHFCF₃ (CAS No. 3330-14-1).

In some embodiments, the partially fluorinated ether solvent corresponds to the formula:

CpF2p+1—O—CqH2q+1

wherein q is an integer from 1 to and 5, for example 1, 2, 3, 4 or 5, and p is an integer from 5 to 11, for example 5, 6, 7, 8, 9, 10 or 11. Preferably, CₚF₂ₚ₊₁ is branched. Preferably, CₚF₂ₚ₊₁ is branched and q is 1, 2 or 3.

Representative solvents include for example 1,1,1,2,2,3,4,5,5,5-decafluoro-3-methoxy-4-(trifluoromethyl)pentane and 3-ethoxy-1,1,1,2,3,4,4,5,5,6,6,6-dodecafluroro-2-(trifluoromethyl)hexane. Such solvents are commercially available, for example, under the trade designation NOVEC from 3M Company, St. Paul, MN.

The fluorinated (e.g. ethers and polyethers) solvents may be used alone or in combination with other solvents, which may be fluorochemical solvents or non-fluorochemical solvents. When a non-fluorochemical solvent is combined with a fluorinated solvent, the concentration non-fluorochemical solvent is typically less than 30, 25, 20, 15, 10 or 5 wt-% with respect to the total amount of solvent. Representative non-fluorochemical solvents include ketones such as acetone, MEK, methyl isobutyl ketone, methyl amyl ketone and NMP; ethers such as tetrahydrofuran, 2-methyl tetrahydrofuran and methyl tetrahydrofurfuryl ether; esters such as methyl acetate, ethyl acetate and butyl acetate; cyclic esters such as delta-valerolactone and gamma-valerolactone.

The composition further comprises fluoropolymer particles.

In some embodiments, the fluoropolymer particles may be characterized as an “agglomerate” (e.g. of latex particles), meaning a weak association between primary particles such as particles held together by charge or polarity. Agglomerates are typically physically broken down into smaller entities such as primary particles during preparation of the coating solution. In other embodiments, the fluoropolymer particles may be characterized as an “aggregate”, meaning strongly bonded or fused particles, such as covalently bonded particles or thermally bonded particles prepared by processes such as sintering, electric arc, flame hydrolysis, or plasma. Aggregates are typically not broken down into smaller entities such as primary particles during preparation of the coating solution. “Primary particle size” refers to the mean diameter of a single (non-aggregate, non-agglomerate) particle.

At least a portion of the fluoropolymer particles have a particle size of greater than 1 micron. In typical embodiments, the fluoropolymer particles have an average particle size of no greater than 75, 70, 65, 60, 55, 50, 45, 35, 30, 30, 25, 20, 15, 10, or 5 microns, In some embodiments, the particle size of the fluoropolymer particles is less than the thickness of the fluoropolymer coating or fluoropolymer film layer. The average particle size is typically reported by the supplier. The particle size of the fluoropolymer particles of the fluoropolymer coating or fluoropolymer film layer can be determined by microscopy.

In some embodiments, the fluoropolymer particles comprise a mixture of particles including fluoropolymer particles having a particle size of greater than 1 micron and fluoropolymer particles having a particle size of 1 micron or less. In some embodiments, the submicron fluoropolymer particle size range may be about 50 to about 1000 nm, or about 50 to about 400 nm, or about 50 to about 200 nm.

In one embodiment, such coating composition is prepared by blending a latex containing (e.g. crystalline) fluoropolymer particles with a latex containing amorphous fluoropolymer particles.

The latexes can be combined by any suitable manner such as by vortex mixing for 1-2 minutes, The method further comprises coagulating the mixture of latex particles. Coagulation may be carried out, for example, by chilling (e.g., freezing) the blended latexes or by adding a suitable salt (e.g., magnesium chloride). Chilling is especially desirable for coatings that will be used in semiconductor manufacturing and other applications where the introduction of salts may be undesirable. The method further comprising optionally washing the coagulated mixture of amorphous fluoropolymer particles and crystalline fluoropolymer particles. The washing step may substantially remove emulsifiers or other surfactants from the mixture and can assist in obtaining a well-mixed blend of substantially unagglomerated dry particles. In some embodiments, the surfactant level of the resulting dry particle mixture may, for example, be less than 0.1% by weight, less than 0.05% by weight or less than 0.01% by weight. The method further comprises drying the coagulated latex mixture. The coagulated latex mixture can be dried by any suitable means such as air drying or oven drying. In one embodiment, the coagulated latex mixture can be dried at 100° C. for 1-2 hours.

In some embodiments, the dried coagulated latex mixture can be dissolved in a solvent suitable for dissolving the amorphous fluoropolymer particles to form a stable coating composition containing a homogeneous dispersion of the crystalline fluoropolymer particles in a solution of the amorphous fluoropolymer. In other embodiments, the dried coagulated latex mixture can be thermally processed.

The coating solution can be utilized to provide a coating on a substrate by applying a layer of the coating composition to a surface of a substrates and drying (i.e. removing the fluorinated solvent by evaporation) the coating composition. In some embodiments, the method further comprises heating the coated substrate to a temperature above the melt temperature of the fluoropolymer particles to sinter the fluoropolymer particles.

In some embodiments, the method further comprises rubbing (e.g. buffing, polishing) the dried layer thereby forming an amorphous fluoropolymer binder layer containing (e.g. crystalline) micron and optionally submicron fluoropolymer particles. A variety of rubbing techniques can be employed at the time of coating formation or later when the coated article is used or about to be used. Simply wiping or buffing the coating a few times using a cheesecloth or other suitable woven, nonwoven or knit fabric will often suffice to form the desired thin layer. Those skilled in the art will appreciate that many other rubbing techniques may be employed. Rubbing can also reduce haze in the cured coating.

The crystalline fluoropolymer particles at the coating surface forms a thin, continuous or nearly continuous fluoropolymer surface layer disposed on the underlying coating comprised of the amorphous fluoropolymer. In preferred embodiments the thin crystalline fluoropolymer layer is relatively uniformly smeared over the underlying coating and appears to be thinner and more uniform than might he the case if the fluoropolymer particles had merely undergone fibrillation (e.g., due to orientation or other stretching).

Average roughness (Ra) of the surface is the arithmetic average of the absolute values of the surface height deviation measured from the mean plane. The fluoropolymer layer or film has a low average roughness. in some embodiments, Ra is at least 40 or 50 nm, ranging up to 100 nm before rubbing. In some embodiments, the surface after rubbing is at least 10, 20, 30, 40, 50 or 60% smoother. In some embodiments, Ra is less than 35, 30, 25, or 20 nm after rubbing.

When a thin coating is prepared from micron sized fluoropolymer particles the average roughness can be greater. In some embodiments, the average roughness is micron sized. However, when the thickness of the coating or fluoropolymer film is greater than the particle size of the (e.g. crystalline) fluoropolymer particles, the surface of the fluoropolymer coating or film can have a low average roughness as previously described.

An advantage of the coating compositions described herein is that the coating compositions can be used to prepare coatings of high or low thickness. In some embodiments, the dried and cured coating has a thickness of 0.1 microns to 10 mils. In some embodiments, the dried and cured coating thickness is at least 0.2, 0.3, 0.4, 0.5, or 0.6 microns. In some embodiments, the dried and cured coating thickness is at least 1, 2, 3, 4, 5, 6, 7, 8, 9, or 10 microns ranging up to 100, 150, or 200 microns,

In typical embodiments, the fluoropolymer particles are crystalline fluoropolymer particles. A variety of crystalline fluoropolymer particles may be employed including mixtures of different crystalline fluoropolymer particles. The crystalline fluoropolymer particles typically have high crystallinity and therefore a significant melting point (peak maximum) as determined by differential scanning calorimetry in accordance with DIN EN ISO 11357-3:2013-04 under nitrogen flow and a heating rate of 10° C./min. Thus, the fluoropolymer particles are typically thermoplastic.

For example, the crystalline fluoropolymer particles may include particles of fluoropolymers having a Tm of at least 100, 110, 120, or 130° C. In some embodiments, the crystalline fluoropolymer particles may include particles of fluoropolymers having a Tm no greater than 350, 340, 330, 320, 310 or 300° C.

The crystalline fluoropolymer particles typically have a fluorine content greater than about 50 weight percent. Also, the fluoropolymer particles may include particles of fluoropolymers having a fluorine content between about 50 and about 76 weight percent, between about 60 and about 76 weight percent, or between about 65 and about 76 weight percent.

Representative crystalline fluoropolymers include, for example, perfluorinated fluoropolymers such as 3M™ Dyneon™ PTFE Dispersions TF 5032Z, TF 50332, TF 5035Z, TF 5050Z, TF 5135GZ, and TF 5070GZ; and 3M™ Dyneon™ Fluorothermoplastic Dispersions PFA 6900GZ, PFA 6910GZ, FEP 6300GZ, THV 221, THV 340Z, and THY 800.

Other suitable fluoropolymer particles are available from suppliers such as Asahi Glass, Solvay Solexis, and Daikin Industries and will be familiar to those skilled in the art.

Commercial aqueous dispersion usually contain non-ionic and/or ionic surfactants at concentration up to 5 to 10 wt. %. These surfactants are substantially removed by washing the coagulated blends. A residual surfactant concentration of less than 1, 0.05, or 0.01 wt. % may be present. Quite often it is more convenient to use the “as polymerized” aqueous fluoropolymer-latexes as they do not contain such higher contents of non-ionic/ionic surfactants.

As previously described, the crystalline fluoropolymers have a melt point that can be determined by DSC. Crystallinity depends on the selection and concentration of polymerized monomers of the fluoropolymer. For example, PTFE homopolymers (containing 100% TFE-units) have a melting point (Tm) above 340° C. The addition of comonomers, such as the unsaturated (per)fluorinated alkyl ethers, reduces the Tm. For example, when the fluoropolymer contains about 3-5 wt. % of polymerized units of such comonomer, the Tm is about 310° C. As yet another example, when the fluoropolymer contains about 15-20 wt. % of polymerized units of HFP, the Tm is about 260-270° C. As yet another example, when the fluoropolymer contains 30 wt. % of polymerized units of (per)fluorinated alkyl ethers (e.g. PMVE) or other comonomer(s) that reduce the crystallinity the fluoropolymer no longer has a detectable melting point via DSC, and thus is characterized as being amorphous.

In some embodiments, the crystalline fluoropolymer particles contain at least 40, 45, 50, 55, 60, 65, 70, 75. 80, 85, 90, 95 or about 100 wt. % of polymerized units of TFE. The fluoropolymer particles typically have a greater amount of polymerized units of TFE than the crosslinked fluoropolymer. More typically the crystalline fluoropolymer particles contain at least 85, 90, 95 or about 100 wt. % of polymerized units of TFE. Further, the crystalline fluoropolymer particles typically comprise a lower concentration of unsaturated (per)fluorinated alkyl ethers (e.g. PMVE) than the amorphous flurorpolymer. In typical embodiments, the crystalline fluoropolymer particles contain less than 30, 25, 20, 15, 14, 13, 12, 11, 10, 9, 8, 7, 6, or 5 wt. % of polymerized units of (per)fluorinated alkyl ethers (e.g. PMVE).

In some embodiments, the crystalline fluoropolymers are copolymers formed from the constituent monomers known as tetrafluoroethylene (“TFE”), hexafluoropropylene (“HFP”), and vinylidene fluoride (“VDF,” “VF2,”). The monomer structures for these constituents are shown below:

TFE: CF₂═CF₂ (1)

VDF: CH₂═CF₂ (2)

HFP: CF₂═CF—CF₃ (3)

In some embodiments, the crystalline fluoropolymer consists of at least two of the constituent monomers (HFP and VDF), and in some embodiments all three of the constituents monomers in varying amounts.

The Tin depends on the amounts of TFE, HFP, and VDF. For example, a fluoropolymer comprising about 45 wt. % of polymerized units of TFE, about 18 wt. % of polymerized units of HFP, and about 37 wt. % of polymerized units of VDF has a Tm of about 120° C. As yet another example, a fluoropolymer comprising about 76 wt. % of polymerized units of TFE, about 11 wt. % of polymerized units of HFP, and about 13 wt. % of polymerized units of VDF has a Tm of about 240° C. By Increasing the polymerized units of HFP/VDF, while reducing the polymerized units of TFE, the fluoropolymer becomes amorphous. An overview of crystalline and amorphous Fluoropolymers is described by Ullmann's Encyclopedia of Industrial Chemistry (7^{th} Edition, 2013 Wiley-VCH Verlag. 10. 1002/14356007.a11 393 pub 2) Chapter: Fluoropolymers, Organic.

The crystalline fluoropolymer particles and amorphous fluoropolymer particles may be combined in a variety of ratios. For example, the coating composition contains about 5 to about 95 weight percent crystalline fluoropolymer particles and about 95 to about 5 weight percent amorphous fluoropolymer, based on the total weight percent of solids (i.e. excluding the solvent) In some embodiments, the coating composition contains about 10 to about 75 weight percent crystalline fluoropolymer particles and about 90 to about 25 weight amorphous fluoropolymer.

In some embodiments, the coating composition or fluoropolymer film contains about 10 to about 50, 55, 60, 65, 70, 75, or 80 weight percent crystalline fluoropolymer particles and about 90 to about 50 weight percent amorphous fluoropolymer. In some embodiments, the coating 35 composition contains about 10 to about 30 weight percent crystalline fluoropolymer particles and about 90 to about 70 weight percent amorphous fluoropolymer. The fluoropolymer particles may have a particle size greater than 1 micron or a portion of the fluoropolymer particles may have a particle size greater than 1 micron and a portion of the fluoropolymer particles may have a particle size of 1 micron or less,

The weight ratio of fluoropolymer particles having a particle size greater than 1 micron to fluoropolymer particles having a particle size of 1 micron or less typically ranges from 1:1 to 10:1. In some embodiments, the weight ratio of larger to smaller fluoropolymer particles is at least 2:1, 3:1, 4:1, 5:1, 6:1, 7:1, 8:1 or 9:1.

Compositions containing curable fluoroelastomers may further contain additives as known in the art. Examples include acid acceptors. Such acid acceptors can be inorganic or blends of inorganic and organic acid acceptors. Examples of inorganic acceptors include magnesium oxide, lead oxide, calcium oxide, calcium hydroxide, dibasic lead phosphate, zinc oxide, barium carbonate, strontium hydroxide, calcium carbonate, hydrotalcite, etc. Organic acceptors include epoxies, sodium stearate, and magnesium oxalate. Particularly suitable acid acceptors include magnesium oxide and zinc oxide. Blends of acid acceptors may be used as well. The amount of acid acceptor will generally depend on the nature of the acid acceptor used. Typically, the amount of acid acceptor used is between 0.5 and 5 parts per 100 parts of fluorinated polymer.

The fluoropolymer composition may contain further additives, such as stabilizers, surfactants, ultraviolet (“UV”) absorbers, antioxidants, plasticizers, lubricants, fillers, and processing aids typically utilized in fluoropolymer processing or compounding, provided they have adequate stability for the intended service conditions. A particular example of additives includes carbon particles, like carbon black, graphite, soot. Further additives include but are not limited to pigments, for example iron oxides, titanium dioxides. Other additives include but are not limited to clay, silicon dioxide, barium sulphate, silica, glass fibers, or other additives known and used in the art.

In some embodiments, the fluoropolymer composition comprises silica, glass fibers, thermally conductive particles, or a combination thereof. Any amount of silica and/or glass fibers and/or thermally conductive particles may be present. in some embodiments, the amount of silica and/or glass fibers is at least 0.05, 0.1, 0.2, 0.3 wt. % of the total solids of the composition. In some embodiments, the amount of silica and/or glass fibers is no greater than 5, 4, 3, 2, or 1 wt. % of the total solids of the composition. Small concentrations of silica can be utilized to thicken the coating composition. Further, small concentrations of glass fibers can be used to improve the strength of the fluoropolymer film. In other embodiments, the amount of glass fibers can be at least 5, 10, 15, 20, 25, 35, 40, 45 or 50 wt-% of the total solids of the composition. The amount of glass fibers is typically no greater than 55, 50, 45, 40, 35, 25, 20, 15, or 10 wt. %. In some embodiments, the glass fibers have a mean length of at least 100, 150, 200, 250, 300, 350, 400, 450, 500 microns. In some embodiments, the glass fibers have a mean length of at least 1, 2, or 3 nun and typically no greater than 5 or 10 mm. In some embodiments, the glass fibers have a mean diameter of at least 1, 2, 3, 4, or 5 microns and typically no greater than 10, 15, 30, or 25 microns. The glass fibers can have aspect ratio of at least 3:1, 5:1, 10:1, or 15:1.

In some embodiments, the fluoropolymer composition is free of (e.g. silica) inorganic oxide particles. In other embodiments, the fluoropolymer composition comprises (e.g. silica and/or thermally conductive) inorganic oxide particles. In some embodiments, the amount of (e.g. silica and/or thermally conductive) inorganic oxide particles is at least 5, 10, 15, 20, 25, 30, 35, 40, or 50 wt. % of the total solids of the composition. In some embodiments, the amount of (e.g. silica and/or thermally conductive) inorganic oxide particles is no greater than 90, 85, 80, 75, 70, or 65 wt. % of the total solids of the composition, Various combinations of silica and thermally conductive particles can be utilized. In some embodiments, the total amount of (e.g. silica and thermally conductive) inorganic oxide particles or the amount of a specific type of silica particle (e.g. fused silica, fumed silica, glass bubbles, etc.) or thermally conductive particle (e.g. boron nitride, silicon carbide, aluminum oxide, aluminum trihydrate) is no greater than 60, 55, 50, 45, 40, 35, 30, 25, 20, 15, 10, or 5 wt. % of the total solids of the composition. Higher concentrations of (e.g. silica) inorganic oxide particles can be favorable to further reducing the dielectric properties. Thus, the compositions including (e.g. silica) inorganic oxide particles can have even lower dielectric properties than the crosslinked fluoropolymer alone.

In some embodiments, the (e.g. silica) inorganic oxide particles and/or glass fibers have a dielectric contant at 1 GHz of no greater than 7, 6.5, 6, 5.5, 5, 4.5, or 4. In some embodiments, the (e.g. silica) inorganic oxide particles and/or glass fibers have a dissipation factor at 1 GHz of no greater than 0.005, 004, 0.003, 0.002, or 0.0015.

In some embodiments, the composition comprises inorganic oxide particles or glass fibers that comprise predominantly silica. In some embodiments, the amount of silica is typically at least 50, 60, 70, 75, 80, 85, or 90 wt. % of the inorganic oxide particles or glass fibers, In some embodiments, the amount of silica is typically at least 90, 91, 92, 93, 94, 95, 96, 97, 98, 99, or greater (e.g. at least 99.5, 99.6, or 99.7) wt-% silica. Higher silica concentrations typically have lower dielectric constants. In some embodiments, (e.g. fused) silica particle can further comprise small concentration of other metals/meta oxides such as Al₂O₃, Fe₂O₅, TiO₂, K₂O, CaO, MgO and Na₂O. In some embodiments, the total amount of such metals/metal oxides (e.g. Al₂O₃, CaO and MgO) is independently no greater than 30, 25, 20, 15, or 10 wt. %. In some embodiments, the inorganic oxide particles or glass fibers may comprise B₂O₃. The amount of B₂O₃ can range up to 25 wt. % of the inorganic oxide particles or glass fibers. In other embodiments, (e.g. fumed) silica particle can further comprise small concentration of additional metals/metal oxides such as Cr, Cu, Li, Mg, Ni, P and Or. In some embodiments, the total amount of such metals or metal oxides is no greater 5, 4, 3, 2, or 1 wt. %. In some embodiments, the silica may be described as quartz. The amount of non-silica metals or metal oxides can be determined by uses of inductively coupled plasma mass spectrometry. The (e.g. silica) inorganic oxides particles are typically dissolved in hydrofluroic acid and distilled as H₂SiF₆ at low temperatures.

In some embodiments, the inorganic particles may be characterized as an “agglomerate”, meaning a weak association between primary particles such as particles held together by charge or polarity. Agglomerate are typically physically broken down into smaller entities such as primary particles during preparation of the coating solution. In other embodiments, the inorganic particles may be characterized as an “aggregate”, meaning strongly bonded or fused particles, such as covalently bonded particles or thermally bonded particles prepared by processes such as sintering, electric arc, flame hydrolysis, or plasma. Aggregates are typically no broken down into smaller entities such as primary particles during preparation of the coating solution. “Primary particle size” refers to the mean diameter of a single (non-aggregate, non-agglomerate) particle.

The (e.g. silica) particles may have various shapes such as spherical, ellipsoid, linear or branched. Fused and fumed silica aggregates are more commonly branched. The aggregate size is commonly at least 10X the primary particle size of discrete part.

In other embodiments, the (e.g. silica) particles may be characterized as glass bubbles. The glass bubble may be prepared from soda lime borosilicate glass. In this embodiment, the glass may contain about 70 percent silica (silicon dioxide), 15 percent soda (sodium oxide), and 9 percent lime (calcium oxide), with much smaller amounts of various other compounds.

In some embodiments, the inorganic oxide particles may be characterized as (e.g. silica) nanoparticles, having a mean or median particles size less than 1. micron. In some embodiments, the mean or median particle size of the (e.g. silica) inorganic oxide particles is at 500 or 750 nm. In other embodiments, the mean particle size of the (e.g. silica) inorganic oxide particles may be at least 1, 1.5, 2, 2.5, 3, 3.5, 4, 4.5, 5, 5.5, 6, 6.5, 7, 7.5, 8, 8.5, 9, 9.5 or 10 microns. In some embodiments, the mean particle size in no greater than 30, 25, 20, 15, or 10 microns. In some embodiments, the composition comprises little or no (e.g. colloidal silica) nanoparticles having a particle of 100 nanometers or less. The concentration of (e.g. colloidal silica) nanoparticles is typically less than (10, 9, 8, 7, 6, 5, 4, 3, 2, or 1 wt. %) The inorganic oxide (e.g. silica particle) may comprise a normal distribution of particle sizes having a single peak or a distribution of particles having two or more peaks.

In some embodiments, no greater than 1 wt. % of the (e.g. silica) inorganic oxide particles have a particle size greater than or equal to 3 or 4 microns. in some embodiments, no greater than 1 wt. % of the (e.g. silica) inorganic oxide particles have a particle size greater than or equal to 5 or 10 microns. In other embodiments, no greater than 5, 4, 3, 2, or 1 wt. % of the particles have a particle size greater than 45 microns. In some embodiments, no greater than 1 wt. % of the particles have a particle size ranging from 75 to 150 microns.

In some embodiments, the mean or median particle size refers to the “primary particle size” referring to the mean or median diameter of discrete a non-aggregated, non-agglomerated particles. For example, the particle size of colloidal silica or glass bubbles is typically the mean or median particle size of In preferred embodiments, the mean or median particle size refers to the mean or median diameter of the aggregates. The particle size of the inorganic particles can be measured using transmission electron microscopy. The particle size of the fluoropolymer coating solution can be measured using dynamic light scattering.

In some embodiments, the (e.g. silica) inorganic particles have a specific gravity ranging from 2.18 to 2.20 glee.

Aggregated particles, such as in the case of fumed and fused (e.g. silica) particles, can have a lower surface area than primary particles of the same size. In some embodiments, the (e.g. silica) particle have a BET surface area ranging from aobout 50 to 500 m²/g. In some embodiments, the BET surface area is less than 450, 400, 350, 300, 250, 200, 150, or 100 m²/g. In some embodiments, the inorganic nanoparticles may be characterized as colloidal silica. It is appreciated that unmodified colloidal silica nanoparticles commonly comprise hydroxyl or silanol functional groups on the nanoparticle surface and are typically characterized as hydrophilic.

In some embodiments, (e.g. silica aggregate) inorganic particles and especially colloidal silica nanoparticles are surface treated with a hydrophobic surface treatment. Common hydrophobic surface treatments include compounds such as alkoxylsilanes (e.g. octadecytriethoxysilane), silazane, or siloxanes. Various hydrophobic fumed silicas are commercially available from AEROSIL™, Evonik, and various other suppliers. Representative hydrophobic fumed silica include: AEROSIL™ grades R 972, R 805, RX 300, and NX 90 S.

In some embodiments, (e.g. silica aggregate) inorganic particles are surface treated with a fluorinated alkoxysilane silane compound. Such compounds typically comprise a perfluoroalkyl or perfluoropolyether group. The perfluoroalkyl or perfluoropolyether group typically has no greater than 4, 5, 6, 7, 8 carbon atoms. The alkoxysilane group can be bonded to the alkoxy silane group with various divalent linking groups including alkylene, urethane, and —SO₂N(Me)—. Some representative fluorinated alkoxy silanes are described in U.S. Pat. No. 5,274,159 and WO2011/043973; incorporated herein by reference. Other fluorinated alkoxy silanes are commercially available.

The fluoropolymer compositions may be prepared by mixing the polymer, the curing agent(s) including at least one ethylenically unsaturated curing agent, at least one compound with an electron donor group, optional additives and the fluorinated solvent. In some embodiments, the fluoropolymer is first dissolved in the fluorinated solvent and the other additives, including the curing agent(s) and electron donor compound are added thereafter.

In some embodiments, the fluoropolymer composition comprises thermally conductive particles.

In some embodiments, the thermally conductive inorganic particles are preferably an electrically non-conductive material. Suitable electrically non-conductive, thermally conductive materials include ceramics such as metal oxides, hydroxides, oxyhydroxides, silicates, borides, carbides, and nitrides. Suitable ceramic fillers include, e.g., silicon oxide, zinc oxide, alumina trihydrate (ATE) (also known as hydrated alumina, aluminum oxide, and aluminum trihydroxide), aluminum nitride, boron nitride, silicon carbide, and beryllium oxide. Other thermally conducting fillers include carbon-based materials such as graphite and metals such as aluminum and copper.

Combinations of different thermally conductive materials may be utilized. Such materials are not electrically conductive, i.e. have an electronic band gap greater than 0 eV and in some embodiments, at least 1, 2, 3, 4, or 5 eV. In some embodiments, such materials have an electronic band gap no greater than 15 or 20 eV. In this embodiment, the composition may optionally further comprise a small concentration of thermally conductive particles having an electronic band gap of less than 0 eV or greater than 20 eV.

In favored embodiments, the thermally conductive particles comprise a material having a bulk thermal conductivity >10 W/m*K. The thermal conductivity of some representative inorganic materials is set forth in the following table.

Thermally Conductive Materials

| | Thermal | Electronic | | |
|---|---|---|---|---|
| | Conductivity | Band Gap | | |
| Material | (W/m*K) | (eV) | Density | |
| α-Aluminum Oxide¹ | 30 | 5-9 | 3.95 | g/cc |
| Alumina Trihydrate² | 21 | | 2.42-2.45 | g/cc |
| Silicon Carbide (SiC)¹ | 120 | 2.4 | 3.21 | g/cc |
| Hexagonal Boron Nitride | 185-300 | 2.1 | 2.1 | g/cc |
| (BN)¹ | | | | |

In some embodiments, the thermally conductive particles comprise material(s) having a bulk thermal conductivity of at least 15 or 20 W/m*K. In other embodiments, the thermally conductive particles comprise material(s) having a bulk thermal conductivity of at least 25 or 30 W/m*K. In yet other embodiments, the thermally conductive particles comprise material(s) having a bulk thermal conductivity of at least 50, 75 or 100 W/m*K. In yet other embodiments, the thermally conductive particles comprise material(s) having a bulk thermal conductivity of at least 150 W/m*K. In typical embodiments, the thermally conductive particles comprise materials) having a bulk thermal conductivity of no mater than about 350 or 300 W/m*K.

Thermally conductive particles are available in numerous shapes, e.g. spheres and acicular shapes that may be irregular or plate-like. In some embodiments, the thermally conductive particles are crystals, typically have a geometric shape. For example, boron nitride hexagonal crystals are commercially available from Momentive. Further, alumina trihydrate is described as a hexagonal platelet. Combinations of particles with different shapes may be utilized. The thermally conductive particles generally have an aspect ratio less than 100:1, 75:1, or 50:1. In some embodiment, the thermally conductive particles have an aspect ratio less than 3:1, 2.5:1, 2:1, or 1.5:1. In some embodiments, generally symmetrical (e.g., spherical, semi-spherical) particles may be employed.

Boron nitride particles are commercially available from 3M as “3™ Boron Nitride Cooling Fillers”.

In some embodiments, the boron nitride particles has a bulk density of at least 0.05, 0.01, 0.15, 0.03 g/cm³ ranging up to about 0.60, 0.70, or 0.80 g/cm³. The surface area of the boron nitride particle can be <25, <20, <10, <5, or <3 m ²/g. The surface area is typically at least 1 or 2 m²/g.

In some embodiments, the particle size, d(0.1), of the boron nitride (e.g. platelet) particles ranges from about 0.5 to 5 microns. In some embodiments, the particle size, d (0.9), of the boron nitride (e.g. platelet) particles is at least 5 ranging up to 20, 25, 30, 35, 40, 45, or 50 microns.

The coating composition described herein including fluorinated solvent is “stable, meaning that the coating composition remains homogeneous when stored for at least 24 hours at room temperature in a sealed container. In some embodiments, the coating composition is stable for one week or more. “Homogeneous” refers to a coating composition that does not exhibit a visibly separate precipitate or visibly separate layer when freshly shaken, placed in a 100 ml glass container and allowed to stand at room temperature for at least 4 hours.

In some embodiments, the fluoropolymer is first combined with other solid ingredients and in particular with the electron donor (e.g. amine) compounds and ethylenically unsaturated curing agent described herein, as well as the (e.g. silica) inorganic particles when present. The fluoropolymer and amine compounds can be combined in conventional rubber processing equipment to provide a solid mixture, i.e. a solid polymer containing the additional ingredients, also referred to in the art as a “compound”. Typical equipment includes rubber mills, internal mixers, such as Banbury mixers, and mixing extruders. During mixing the components and additives are distributed uniformly throughout the resulting fluorinated polymer “compound” or polymer sheets. The compound is then preferably comminuted, for example by cutting it into smaller pieces and is then dissolved in the solvent.

The fluoropolymer coating solution compositions provided herein are suitable for coating substrates. The fluoropolymer coating solution compositions may be formulated to have different viscosities depending on solvent and fluoropolymer content and the presence or absence of optional additives. The fluoropolymer coating solution compositions typically contain or are solutions of fluoropolymers and may be in the form of liquids or pastes. Preferably, the compositions are liquids and more preferably they are solutions containing one or more fluoropolymer as described herein dissolved in a solvent as described herein.

The fluoropolymer compositions provided herein are suitable for coating substrates and may be adjusted (by the solvent content) to a viscosity to allow application by different coating methods, including, but not limited to spray coating or printing (for example but not limited to ink-printing, 3D-printing, screen printing), painting, impregnating, roller coating, bar coating, dip coating and solvent casting.

Coated substrates and articles may be prepared by applying the fluoropolymer compositions to a substrate and removing the solvent. The curing may occur to, during, or after removing the solvent. The solvent may be reduced or completely removed, for example for evaporation, drying or by boiling it off. After removal of the solvent the composition may be characterized as “dried”.

Methods of making a crosslinked fluoropolymer described herein comprise curing the fluoropolymer with (e.g. UV or e-beam) actinic irradiation. The fluoropolymer composition, substrate, or both are transmissive to the curing radiation. In some embodiments, a combination of UV curing and thermal (e.g. post) curing is utilized. The curing is carried out at an effective temperature and effective time to create a cured fluoroelastomer. Optimum conditions can be tested by examining the fluoroelastomer for its mechanical and physical properties. Curing may be carried out under pressure or without pressure in an oven. A post curing cycle at increased temperatures and or pressure may be applied to ensure the curing process is fully completed. The curing conditions depend on the curing system used.

In some embodiments, the composition is cured by UV-curing. The fluoropolymers of the compositions described here comprise little or no polymerized units of vinylidene fluoride (VDF) (i.e. CH₂═CF₂) or VDF coupled to hexafluoropropylene (HFP). Polymerized units of VDF can undergo dehydrofluorination (i.e. an HF elimination reaction) as described in US2006/0147723. The reaction is limited by the number of polymerized VDF groups coupled to an HFP group contained in the fluoropolymer. The double bonds created as a result of dehydrofluorination can then react (via Michael addition) with an amino alkoxy silane thereby grafting fluorinated pendent alkoxy silane groups onto the fluoropolymer backbone. When irradiated with UV light, such pendent groups can free-radically copolymerize with multifunctional (meth)acrylate compounds.

However, since the fluoropolymers of the compositions described here comprise little or no polymerized units of VDF (i.e. CH₂═CF₂) coupled to an HFP group, the fluoropolymers are not susceptible to the reaction schemes just described. As evident by the forthcoming examples, the amine compound alone can initiate UV-curing in the absence of free-radical photoinitiators. The inclusion of free-radical photoinitiator typically does not increase the crosslinking of the fluoropolymer. This result suggests that the fluoropolymer is not crosslinked via a free-radical mechanism.

Although, conventional free-radical initiators are not required, the composition can optionally further comprise a photoinitiator. In other embodiments, the composition is substantially free of free-radical initiators including such free-radical photoinitiators,

In some embodiments, the UV radiation may have sufficient intensity at a wavelength of at least 190 nm, 200 nm, 210 nm, 220 nm, 230 nm or 240 nm. In some embodiments, the UV radiation may have sufficient intensity at a wavelength no greater than 350 nm, 340 nm, 330 nm, 320 nm, 310 nm, or 290 nm. In some embodiments, the (e.g. UV) actinic radiation has sufficient intensity at a wavelength ranging from 270-290 nm such that in the presence of an (e.g. amine) electron donor a wavelength-induced single electron transfer reaction may occur between C—I bonds. In some embodiments, the UV radiation may have sufficient intensity at a wavelength ranging below 240 nm (e.g. 150-200 nm) such that in the presence of an (e.g. amine) electron donor a wavelength-induced single electron transfer reaction may occur between C—Cl or C—Br bonds. 25 UV light sources can be of various types. Low light intensity sources, such as blacklights, generally provide intensities ranging from 0.1 or 0.5 mW/cm² (millwatts per square centimeter) to 10 mW/cm² (as measured in accordance with procedures approved by the United States National Institute of Standards and Technology as, for example, with a UVIMAP UM 365 L-S radiometer manufactured by Electronic Instrumentation & Technology, Inc., in Sterling, VA). High light intensity sources generally provide intensities greater than 10, 15, or 20 mW/cm² ranging up to 450 mW/cm² or greater. In some embodiments, high intensity light sources provide intensities up to 500, 600, 700, 800, 900 or 1000 mW/cm², UV light to polymerize the ethylenically unsaturated monomer(s) can be provided by various light sources such as light emitting diodes (LEDs), fluorescent blacklights, arc-lamps such as xenon-acre lamps and medium and low pressure mercury lamps (including germicidal lamps), microwave-driven lamps, lasers etc. or a combination thereof. The composition can also be polymerized with higher intensity light sources as available from Fusion UV Systems Inc. Lamps that emit ultraviolet or blue light are typically preferred. The UV exposure time for polymerization and curing can vary depending on the intensity of the light source(s) used. For example, complete curing with a low intensity light course can be accomplished with an exposure time ranging from about 30 to 300 seconds; whereas complete curing with a high intensity light source can be accomplished with shorter exposure time ranging from about 5 to 20 seconds. Partial curing with a high intensity light source can typically be accomplished with exposure times ranging from about 2 seconds to about 5 or 10 seconds. In some embodiments, post curing may be carried out at a temperature between 170° C. and 250° C. for a period of 0.1 to 24 hours.

In some embodiments, post curing of the fluoropolymer may optionally be carried out at lower temperatures. Post curing at lower temperatures is amenable for coating heat sensitive substrates. In some embodiments, the post curing occurs at a temperature ranging from 100, 110, 120, 130, 135 or 140° C. up to 170° C. for a period of 5-10 minutes to 24 hours. In some embodiments, the temperature is no greater than 169, 168, 167, 166, 165, 164, 163, 162, 161, or 160° C. In some embodiments, the temperature is no greater than 135, 130, 125, or 120° C. In favored embodiments, after curing the fluoropolymer is sufficiently crosslinked such that at least 80, 85, 90, 95 or 100 wt. % or greater cannot be dissolved 12 hours at 25° C.) in fluorinated solvent (e.g. 3-ethoxy perfluorinated 2-methyl hexane) at a weight ratio of 5 grains of fluoropolymer in 95% by weight of fluorinated solvent.

The compositions may be used for impregnating substrates, printing on substrates (for example screen printing), or coating substrates, for example but not limited to spray coating, painting dip coating, roller coating, bar coating, solvent casting, paste coating. The substrate may be organic, inorganic, or a combination thereof Suitable substrates may include any solid surface and may include substrate selected from glass, plastics (e.g. polycarbonate), composites, metals (stainless steel, aluminum, carbon steel), metal alloys, wood, paper among others. The coating may be colored in case the compositions contains pigments, for example titanium dioxides or black fillers like graphite or soot, or it may be colorless in case pigments or black fillers are absent,

Bonding agents and primers may be used to pretreat the surface of the substrate before coating. For example, bonding of the coating to metal surfaces may be improved by applying a bonding agent or primer. Examples include commercial primers or bonding agents, for example those commercially available under the trade designation CHEMLOK.

Articles containing a coating from the compositions provided herein include but are not limited to impregnated textiles, for example protective clothing. Another example of an impregnated textile is a glass scrim impregnated with the (e.g. silica containing) fluoropolymer composition described herein. Textiles may include woven or non-woven fabrics, Other articles include articles exposed to corrosive environments, for example seals and components of seals and valves used in chemical processing, for example but not limited to components or linings of chemical reactors, molds, chemical processing equipment for example for etching, or valves, pumps and tubing, in particular for corrosive substances or hydrocarbon fuels or solvents;

combustion engines, electrodes, fuel transportation, containers for acids and bases and transportation systems for acids and bases, electrical cells, fuel cells, electrolysis cells and articles used in or for etching.

An advantage of the coating compositions described herein is that the coating compositions can be used to prepare coatings or fluuoroplymer sheets of high or low thickness. In some embodiments, the dried and cured fluoropolymer has a thickness of 0.1 microns to 1 or 2 mils. In some embodiments, the dried and cured fluoropolymer thickness is at least 0.2, 0.3, 0.4, 0.5, or 0.6 microns. In some embodiments, the dried and cured fluoropolymer thickness is at least 1, 2, 3, 4, 5, or 6 microns.

In typical embodiments, the dried and cured (i.e. crosslinked) composition has a low dielectric constant (Dk), typically less than 2.75, 2.70, 2.65, 2.60, 2.55, 2.50, 2.45, 2.40, 2.35, 2.30, 2.25, 2.20, 2.15, 2.20, 2.15. 2.10, 2.05, 2.00, 1.95, 1.90. In some embodiments, the dielectric constant is at least 1.90, 1.95, or 2.00, The dried and cured (i.e. crosslinked) composition has a low dielectric loss, typically less than 0.01, 0.009, 0.008, 0.007, 0.006, 0.005, 0.004, 0.003, 0.002, 0.001, 0.0009, 0.0008, 0.0007, 0.0006, 0.0005, 0.0004, 0.0003. In some embodiments, the dielectric loss is at least 0.00022, 0.00023. 0.00024, 0.00025.

The dried and cured coating can exhibit good adhesion to various substrates (e.g. glass, polycarbonate,), as evidence by the coating exhibiting a 2, and preferably a 3 or 4 according to the Boiling Water Test described in PCT/US2019/036460. In some embodiments, the dried and cured coating is durable as evidence by the coating exhibiting a 2, and preferably a 3 or 4 according to the Abrasion Test described in previously cited PCT/US20191036460. In some embodiments, the coating is durable, according to the Abrasion Test after being subjected to the Boiling Water Test.

The dried and cured coating can exhibit good adhesion to metals, such as copper. For example, in some embodiments, the T-peel to copper foil is at least 0.1, 0.2, 0.3, 0.4, 0.5 or 0.6 N/mm ranging up to at least 1 N/mm (i.e. 10 N/cm), 1.5 N/mm 2 N/mm or 2.5 N/mm or greater as determined by the test method described in the examples.

In some embodiments, the dried and cured coating has good hydrophobic and oleiphobic properties according to the Black Permanent Marker Resistance Test described in previously cited PCT/US2019/036460, i.e. the marker fluid beads and is easy to remove with a paper towel or cloth.

In some embodiments, the dried and cured coating has good hydrophobic and oleiphobic properties, as determined by Contact Angle Measurements (as determined according to the test method described in the examples). In some embodiments, the static, advancing and/or receding contact angle with water can be at least 100, 105, 110, 115, 120, 125 and typically no greater than 130 degrees. In some embodiments, the advancing and/or receding contact angle with hexadecane can be at least 60, 65, 70, or 75 degrees. In some embodiments, the coating exhibits such contact angles, after being subjected to the Boiling Water Test or after being subject the Boiling Water Test and the Abrasion Test (as determined according to the test method described in previously cited PCT/US2019/036460).

In some embodiments, the dried and cured coating exhibits good corrision resistance not corroded) according to the Acid/Base Corrison Test described in previously cited PCT/US2019/036460.

In some embodiments, the dried and cured coating (e.g. film) exhibits low water absorption e.g. less than 0.5, 0.4, 0.3, 0.2, or 0.1 as determined by the Moisture Uptake test method described in the examples.

In some embodiments, the composition exhibits a low coefficent of thermal expansion e.g. less than 150, 100, 50, 40, 30, 20 or 10 as determined by the test method described in the examples. For some insulation layer uses the coefficent of thermal expansion is less critical and may range up to 175, 200 or 225.

As used herein the term “partially fluorinated alkyl” means an alkyl group of which some but not all hydrogens bonded to the carbon chain have been replaced by fluorine. For example, an F₂HC—, or an FH₂C— group is a partially fluorinated methyl group. Alkyl groups where the remaining hydrogen atoms have been partially or completely replaced by other atoms, for example other halogen atoms like chlorine, iodine and/or bromine are also encompassed by the term “partially fluorinated alkyl” as long as at least one hydrogen has been replaced by a fluorine. For example, residues of the formula F₂ClC— or FHClC— are also partially fluorinated alkyl residues.

A “partially fluorinated ether” is an ether containing at least one partially fluorinated group, or an ether that contains one or more perfluorinated groups and at least one non-fluorinated or at least one partially fluorinated group. For example, F₂HC—O—CH₃, F₃C—O—CH₃, F₂HC—O—CFH₂, and F₂HC—O—CF₃ are examples of partially fluorinated ethers. Ethers groups where the remaining hydrogen atoms have been partially or completely replaced by other atoms, for example other halogen atoms like chlorine, iodine and/or bromine are also encompassed by the term “partially fluorinated alkyl” as long as at least one hydrogen has been replaced by a fluorine. For example, ethers of the formula F₂ClC—O—CF₃ or FHClC—O—CF₃ are also partially fluorinated ethers.

The term “perfluorinated alkyl” or “perfluoro alkyl” is used herein to describe an alkyl group where all hydrogen atoms bonded to the alkyl chain have been replaced by fluorine atoms. For example, F₃C— represents a perfluoromethyl group.

A “perfluorinated ether” is an ether of which all hydrogen atoms have been replaced by fluorine atoms. An example of a perfluorinated ether is F₃C—O—CF₃.

The following examples are provided to further illustrate the present disclosure without any intention to limit the disclosure to the specific examples and embodiments provided.

### EXAMPLES

Unless otherwise noted, all parts, percentages, ratios, etc. in the Examples and the rest of the specification are by weight. Unless otherwise indicated, all other reagents were obtained, or are available from fine chemical vendors such as Sigma-Aldrich Company, St. Louis, Missouri, or may be synthesized by known methods. Table 1 (below) lists materials used in the examples and their sources.

TABLE 1
Materials List

| DESIGNATION | DESCRIPTION | SOURCE |
|---|---|---|
| PFE-3 | Perfluoroelastomer latex or coagulated gum | 3M Dyneon |
| | comprising a copolymer of 65.8 mol % TFE, 33 | |
| | mol PMVE, 1.2 mol% of a nitrile vinylether (U.S. | |
| | Pat. No. 7,019,083) | |
| THV | Fluoroplastic particles obtained under the trade | 3M Dyneon |
| | designation “THV-221AZ” | |
| PFE-4 | Perfluoroelastomer latex or coagulated gum | 3M Dyneon |
| | obtained under the trade designation “PFE | |
| | 191TZ” | |
| PFA-1 | Fluoroplastic powder, a copolymer of CF2═CF2 | 3M Dyncon |
| | & CF₂═CFOCF₂CF₂CF₃ (5 wt. %); median | |
| | particle size 8-10 micrometers | |
| PFA-2 | Latex (30 w % solids) comprising a polymer of TFE | 3M Dyneon |
| | (97 w %), PMVE (CF2═CF—O—CF3, 2 w %) | |
| | and CF2═CF—CF2—O—C3F7 (1 w %), melting | |
| | point 307° C., MFI (372° C./5 kg) 2 g/10 min; | |
| | 200 nanometers | |
| PTFE9205 | Polytetrafluoroethylene (PTFE) micropowder | 3M Dyneon |
| | (average particle size, 8 micrometers); a | |
| | homopolymer of CF₂═CF₂; obtained under the | |
| | trade designation “3M DYNEON PTFE TF | |
| | 9205” | |
| FHT | Micronized PTFE; homopolymer of CF₂═CF₂; | Micro Powders, Inc., |
| | mean particle size 2-4 micrometers; obtained | Tarrytown, NY |
| | under the trade designation “FLUO HT” PTFE | |
| FS20 | Fused silica (9-16 micrometers), obtained under | 3M Company, St. |
| | the trade designation “3M FUSED SILICA 20” | Paul, MN |
| FS550 | Fused silica (3.5-5.2 micrometers), obtained | 3M Company |
| | under the trade designation “3M FUSED | |
| | SILICA 550” | |
| GB | Thin-walled (0.5-1.5 μm) spherical soda lime | 3M Company |
| | borosilicate glass particles; typical D50 diameter | |
| | (medium) = 20 micrometers; obtained under the | |
| | trade designation “3M GLASS BUBBLES | |
| | iM16K” | |
| FG-Si | Fine ground silica (D90 = 3.5 micrometers), | US Silica Co., Katy, |
| | obtained under the trade designation “MIN-U- | TX |
| | SIL 5” | |
| TEOS | Tetraethyl Orthosilicate | Sigma-Aldrich, St. |
| | | Louis, MO |
| FT3802 | Microglass 3802 (milled E-glass filaments); | Fibertec, |
| | average fiber diameter = 16 micrometers; | Bridgewater, MA |
| | average fiber length = 120 micrometers | |
| BTMSPA | Bis(3-trimethoxysilylpropyl)amine | Gelest Corporation, |
| | | Morrisville, PA |
| Amidine | Perfluoroamidine; obtained under the trade | 3M Dyneon |
| | designation “3M DYNEON PFE 300Z” | |
| HFE-7300 | 3-methoxy perfluorinated 4-methyl pentane | 3M Company |
| | obtained under the trade designation “3M | |
| | NOVEC 7300” | |
| PTFE-5033 | Commercial product obtained under the trade | 3M Dyneon |
| | designation “3M DYNEON PTFE | |
| | DISPERSION TF 5033Z”; particle size | |
| | approximately 200 nanometers | |
| C6Si | n-C₆F₁₃CH₂CH₂Si(OEt)₃ obtained under the | Evonik, Essen, |
| | trade designation “DYNASYLAN F8261” | Germany |
| C4F9-Si | C₄F₉SO₂NMeCH₂CH₂CH₂Si(OMe)₃, Prepared | 3M Company |
| | by the procedure described in Ex-6 of U.S. Pat. | |
| | No. 5,274,159, except using | |
| | C₄F₉SO₂NMeCH₂CH═CH₂ for replacement of | |
| | C₈F₁₇SO₂NEtCH₂CH═CH₂ | |
| BN012 | Boron nitride powder obtained under the trade | 3M Company |
| | designation “BN CFP 012” | |
| QZ-1 | Quartz fiber, 1 millimeter length, 8 micrometer | Shenjiu, Henan |
| | diameter | Province, China |
| BAPTMA | n-Butylaminopropyltrimethoxysilane | Gelest Corporation |
| CQ0382 | Fused silica with surface treatment (D90 = 4 um) | Suzhou Ginet |
| KH-550 | Silane coupling agent; (3- | China National |
| | Aminopropyl)triethoxysilane | Pharmaceutical |
| | | Group Corporation, |
| | | Beijing, China |
| PFE-1 | Coagulated gum obtained from 30 wt. % solids | 3M Dyneon |
| | aqueous perfluoroelastomer latex - 50.4 wt. % | |
| | PMVE, 49.6 wt. % TFE, and 0.4 wt. % iodine, | |
| | having a Mooney value of 40 as can prepared | |
| | according to WO2015/088784 or | |
| | WO2015/134435 | |

### Test Methods

### Split Post Dielectric Resonator Test Method at 25 GHz

All split-post dielectric resonator measurements were performed in accordance with the standard TEC 61189-2-721 near a frequency of 25 GHz. Each thin material or film was inserted between two fixed dielectric resonators. The resonance frequency and quality factor of the posts are influenced by the presence of the specimen, and this enables the direct computation of complex permittivity (dielectric constant and dielectric loss). The geometry of the split dielectric resonator fixture used in our measurements was designed by the Company QWED in Warsaw Poland. This 25 GHz resonator operates with the TE_{old} mode which has only an azimuthal electric field component so that the electric field remains continuous on the dielectric interfaces. The split post dielectric resonator measures the permittivity component in the plane of the specimen. Loop coupling (critically coupled) was used in each of these dielectric resonator measurements. This 25 GHz Split Post Resonator measurement system was combined with Keysight VNA (Vector Network Analyzer Model PNA 8364C 10 MHz-50 GHz). Computations were performed with the commercial analysis Split Post Resonator Software of QWED to provide a powerful measurement tool for the determination of complex electric permittivity of each specimen at 25 GHz.

### Coefficient of Thermal Expansion (CTE) Test Method

CTE measurements were conducted using a Thermomechanical Analyzer (TMA) Q400 from TA Instruments (New Castle, DE). The film samples were cut into rectangle shapes (4.5 millimeters (mm)×24 mm) and mounted on the tension clamp. The samples were heated to at least 150° C. using a ramp rate of 3.00° C./minute and then cooled to room temperature at the same rate. Then the samples were heated again to the target temperature. The CTE calculated from the second cycle was reported.

### Moisture Uptake Test Method

Water absorption measurements were made using a vapor absorption analysis instrument Q500SA from TA Instruments. The sample was placed in a quartz pan located inside a programmable chamber. Approximately 5 milligrams (mg) of sample was used in each measurement. The samples were first dried in the chamber until the weight remained unchanged over 20 minutes. Then the samples were placed under 60° C. and 50% humidity conditions until weight equilibrium was achieved. The water absorption value was calculated based on the weight increase/original weight of the sample.

### T-Peel (Adhesion to Copper) Test Method

Perfluoropolymer composite films were obtained by coating the solutions on a 3M release liner (precoated with a fluorinated release coating) with a No. 24 Meyer rod. The obtained coatings were then dried in a 100° C. oven to remove solvents. The films were then separated from the liners and placed into an aluminum tray and heated at 160-165° C. for 20 minutes.

Films were laminated with 2 pieces of Cu foil (one on the bottom and one on the top) to obtain sandwich structures with perfluoropolymer composite films in the middle. Then the laminated sheets were heated at 200° C. for 10-20 minutes between heated platens of a Wabash MPI (Wabash, IN) hydraulic press and immediately transferred to a cold press. After cooling to room temperature by cold pressing, the resulting sample was subjected to T-peel measurement. The laminated samples were pressed and cut into strips with 1 centimeter (cm) width for T-peel measurement. The measurement was conducted using an Instron electromechanical universal testing machine (Instron Corp., Norwood, MA) using ASTM D1876 standard method for “Peel Resistance of Adhesives,” more commonly known as the ‘T-peel” test. Peel data was generated using an Instron™ model 1125 tester (Instron Corp.) equipped with a Sintech Tester 20 (MTS Systems Corporation, Eden Prairie, MN).

### EXAMPLES

### General Procedure for Perfluoroelastomer PFE-3 Coating Solution Preparations With Aminosilane Ester Crosslinker/Silica Particles

Perfluoroelastomer PFE-3 was prepared by cutting PFE-3 gum into small pieces and placing them into HFE-7300 solvent. The container was well sealed with PTFE tape and paraffin film. The solution was subject to vigorous shaking overnight (approximately 12 hours) to became completely homogenous to obtain a 5 wt % PFE-3 in FIFE-7300 solution (5 g PFE-3 and 95 g HFE-7300).

Bis(3-trimethoxysilylpropyl)amine (BTMSPA) was dissolved or dispersed in HFE-7300 to form 10 wt % solutions or suspensions. BTMSPA in HFE-7300 solution was homogenized using a vortex shaker at 1000 revolutions per minute (rpm) for 10 seconds to form well dispersed slurry before being added to the PFE-3/FIFE-7300 solution. To the PFE-3 solution were added the BTMSPA solution and fillerparticles as indicated in tables 2, 3, and 4. The parts by weight indicated in the formula (e.g., 5, 2) was the mass fraction based on the solid content of PEE-3, For instance, PFE-3+5% BTMSPA means: the solid content of PFE-3/BTMSPA=95:5. The prepared solutions described above were typically stirred under vortex for 1-2 minutes at 2500 rpm. All above prepared solutions were coated on clean PET release liner or copper foil with a No. 24 Meyer rod, and the resulting coatings were normally cured 165° C. for 20 minutes.

### PFE/PEA or PFE/PTFE Co-Coagulations and Dispersion Solution Preparations: Examples 12, 13 and 15 (EX-12, EX-13 and EX-15)

Perfluoroelastomer PFE-3 (30.5 wt %) was mixed with PFA latex (30 wt % obtained from the dilution of 50 wt PFA latex) in a ratio of 7:3 or 8:2, or with PTFE-5033 in a ratio of 7:3 (30 wt % obtained from the dilution of 55 wt % PTFE latex) respectively. The mixed solutions were vortexed for 1-2 minutes. Subsequently, the well-mixed solutions were frozen in a fridge overnight. They were taken out and thawed in warm water. After melting, the precipitates were filtered and washed with deionized water. The obtained solids were dried in an air circulated oven at 60° C. overnight. The dried PFE/PFA & PFE/PTFE coagulated solids were mixed with HFE-7300 separately in 10 wt % solutions.

### General Procedure for Perfluoroelastomer-Perfluoroplastic Micron Particle Coating Solutions and Perfluoroelastomer-Perfluoroplastic PFE/PFA-PFA and PFE/PTFE-PTFE NANO- and Micron-Particle Preparations With Animosilane Ester Crosslinker/Silica Particles

Into vials were placed desired amounts of PTFE or PFA micron particle and silica particle as indicated in the Tables 3 and 4. To the solution was added a small amount of HFE-7300 and subsequently the mixtures were homogenized using a vortex for 1-2 minutes at 2500 rpm to make pastes. To the pastes were subsequently added the desired amounts of the 5 wt % PFE-3/HFE-7300, 10 wt % PFE/PFA or PFE/PTFE in HFE-7300 solutions, floroalkyl alkoxysilane agents and the desired amount of 10 wt % BTMSPA in HFE-7300 solution as described in the tables below (except for EX-15, which has 18 wt % BTMSPA in HFE-7300 solution). The prepared solutions described above were typically stirred under vortex for 1-2 minutes at 2500 rpm and subsequently placed in a shaker at 500 rpm for 1-2 hours before coating. All above prepared solutions were coated on clean PET release liner or copper foil with a No. 24 Meyer rod, and the resulting coatings were normally cured 165° C. for 20 minutes in Tables 3 and 4, below.

TABLE 2
Perfluoropolymer composite coatings and their electric and physical properties

| | | | | | CTE | CTE |
|---|---|---|---|---|---|---|
| CONTROL | FORMULATION, | | | MOISTURE | (5-30° C.), | (60-75° C.), |
| EXAMPLES | parts by weight solid | Dk | Df | UPTAKE | (μm/m)/° C. | (μm/m)/° C. |
| CT-1 | PFE-3/BTMSPA | 2.35 | 0.0022 | | | |
| | (95/5) | | | | | |
| CT-2 | PFE-3/GB/BTMSPA/ | 2.36 | 0.0028 | 0.15% | | |
| | TEOS | | | | | |
| | (80/20/2.5/1.5) | | | | | |
| CT-3 | PFE-3/FS20/BTMSPA | 2.36 | 0.0018 | 0.15% | 110 | 154 |
| | (70/30/5) | | | | | |
| CT-4 | PFE-3/FS550/BTMSPA | | 0.0018 | | 128 | 181 |
| | (70/30/5) | | | | | |
| CT-5 | PFE-3/FS550/C4F9- | | 0.0020 | 0.09% | 128 | 181 |
| | SI/BTMSPA | | | | | |
| | (70/30/1.5/1.5) | | | | | |

TABLE 3
Perfluoropolymer composite coatings containing PTFE or PFA perfluoroplastic
microparticles and their electric and physical properties

| | | MOISTURE | | | | | |
|---|---|---|---|---|---|---|---|
| | | UPTAKE; | | | | | |
| | | 5% to 95% | CTE | DIFFUSION | | | ADHESION |
| | FORMULATION, | RH at 23° C., | (50-120° C.), | RATE at | | | TO COPPER, |
| EX. | parts by weight solid | wt % | (μm/m)/° C. | 23° C., g\hat{ }2/s | Dk | Df | N/cm |
| EX-1 | PFE-3/PTFE9205/FS550/BTMSPA | 0.10 | 106 | 5.40E−09 | 2.03 | 0.0012 | 10.2 |
| | (30/53/15/2) | | | | | | |
| EX-2 | PFE-3/PTFE9205/FS550/BTMSPA | 0.15 | 108 | 3.58E−09 | 2.14 | 0.0012 | 12.3 |
| | (30/48/20/2) | | | | | | |
| EX-3 | PFE-3/PTFE9205/FS550/BTMSPA | 0.12 | 108 | 3.59E−09 | 2.06 | 0.0013 | 13.1 |
| | (30/43/25/2) | | | | | | |
| EX-4 | PFE-3/PTFE9205/FS550/BTMSPA | 0.10 | 156 | | 2.20 | 0.0009 | 14.6 |
| | (40/46/12/2) | | | | | | |
| EX-5 | PFE-3/PTFE9205/FS550/BTMSPA | | | | | | 20.7 |
| | (70/30/20/5) | | | | | | |
| EX-6 | PFE-3/PTFE9205/FS550/FT3802/ | | 116 | | | | |
| | Amidine/BTMSPA/C6Si | | | | | | |
| | (35/48/5/10/1/2/2) | | | | | | |
| EX-7 | PFE-3/PTFE9205/FS550/FT3802/ | | 116 | | | | |
| | Amidine/BTMSPA/C6Si | | | | | | |
| | (35/43/15/5/1/2/2) | | | | | | |
| EX-8 | PFE-3/FHT/FS550/BTMSPA | 0.13 | 155 | | 2.15 | 0.0016 | |
| | (40/46/12/2) | | | | | | |

TABLE 4
Perfluoropolymer composite coatings and their properties, especially their moisture uptake values,
further improved by fluoroalkylsilanes

| | | MOISTURE | | | | | |
|---|---|---|---|---|---|---|---|
| | | UPTAKE; | | | | | |
| | | 5% to 95% | CTE | DIFFUSION | | | ADHESION |
| | FORMULATION, | RH at 23° C., | (50-120° C.), | RATE at | | | TO COPPER, |
| EX. | parts by weight solid | wt % | (μm/m)/° C. | 23° C., g\hat{ }2/s | Dk | Df | N/cm |
| EX-9 | PFE-3/PTFE9205/FS550/ | 0.08 | 129 | 1.25E−08 | 2.08 | 0.00143 | |
| | BTMSPA/C6Si (30/53/15/2/2) | | | | | | |
| EX-10 | PFE-3/PTFE9205/FS550/ | 0.08 | 111 | 1.32E−08 | 2.06 | 0.00136 | |
| | BTMSPA/C6Si (30/48/20/2/2) | | | | | | |
| EX-11 | PFE-3/PTFE9205/FS550/ | 0.10 | 127 | 5.46E−09 | 2.08 | 0.00137 | 9.6 |
| | BTMSPA/C6Si (30/43/25/2/2) | | | | | | |
| EX-12 | [PFE-3/PFA-1 (8:2)]/ | 0.09 | 145 | 6.53E−09 | 2.03 | 0.00122 | |
| | PTFE9205/FS550/BTMSPA | | | | | | |
| | ((45)/40/15/2) | | | | | | |
| EX-13 | [PFE-3/PTFE-5033 (7:3)]/ | 0.19 | 143 | 2.51E−09 | 2.05 | 0.0018 | |
| | PTFE9205/FS550/BTMSPA | | | | | | |
| | (50/35/15/2) | | | | | | |
| EX-14 | PFE-3/BN012/PTFE9205/BTMSPA | | | | 2.38 | 0.0010 | |
| | (60/20/20/2.5) | | | | | | |
| EX-15* | [PFE-3/PFA-2 (7:3)]/ | | | | 2.36 | 0.0009 | |
| | BN012/PTFE9205/BTMSPA | | | | | | |
| | (60/20/20/2.5) | | | | | | |
| EX-16 | PFE-4/FHT/BN012/BTMSPA | | | | 2.32 | 0.0019 | |
| | (60/25/15/2.5) | | | | | | |
| EX-17 | PFE-4/FHT/BN012/QZ-1/BTMSPA | | | | 2.26 | 0.0019 | |
| | (60/25/13/2/2.5) | | | | | | |
| EX-18 | PFE-4/FHT/QZ-1/BTMSPA | | | | 2.05 | 0.0023 | |
| | (60/25/5/2.5) | | | | | | |

*18 wt % BTMPSA in HFE-7300 solution

### Example-19 (EX-19)

PFE-3 was dissolved in HFE-7300 (5 wt %, 28 grams) to create a clear, colorless solution. To this solution was added solid THV-221AZ (0.6 grams). The solid was dispersed throughout th solution by vortexing the mixture for 60 seconds. To the dispersion solution was added BTMSPA. The amount of BTMSPA used was based on the amount of resin present in the solution (2.5% of mass of PFE-3 in solution). The solution was vortexed again to mix it in and then placed on a shaker for 10 minutes.

The solution was coated on release liner using a Gardco wet film applicator (Paul N. Gardner Company, Pompano Beach, FL) set to a 20 mil gap. The film was allowed to air dry at room temperature for 15 minutes and then dried further at 50° C. for an additional 10 minutes. The THV granules were still white and could be removed by gentle rubbing.

The film was then removed from the release liner and split into sections. The sections were then placed on either Kapton, glass, or left on the release liner and then melt-cured at 150° C. for 30 minutes and then 165° C. for an additional 1 hour followed by a slow cool to room temperature. THV granules were melted and clear and could not be removed by rubbing.

### General Procedure for Preparing Curable Perfluoroelastomers by UV Reactions

Perfluoroelastomer PFE-1 solutions were prepared by cutting PFE-1 into small pieces and placing them into a transparent plastic bottle containing HFE-7300 solvent to obtain solutions of designated weight percent PFE-1 in HFE-7300. The container was well sealed and then the solution was subject to vigorous shaking overnight (approximately 12 hours) to become completely homogenous. For example, 10 g PFE-1 was dissolved in 90 g HFE-7300 to obtain a 10 wt. % solution.

Amino silanes and other additives were weighted according to Tables 5 and 6 and dropped into the PEE-1 solutions using syringes. The solutions were immediately shaken using a vortex shaker for 30 seconds to obtain homogeneous mixtures then placed on a 365 nm LED UV roller reactor to initiate the reaction under different UV doses via tuning exposure time. The reacted solutions were then coated onto different substrates using a bar coater. The UV reacted solutions and the coatings were then evaluated for waterproof, shelf-life and other performances.

### Preparation of Low CTE Composite Films

Weighted fused silicas were dispersed in HFE-7300 and agitated by a high speed mixer to form a 50 wt. % dispersion solution which was then added into the UV-exposed PFE-1 solutions and evenly mixed at 2000 rpm using a Thinky Planetary Mixer (Thinky U.S.A., Inc., Laguna Hills, CA) for 3 minutes. The solutions were then coated onto PET substrates using a bar coater. The obtained wet films were dried in a heating oven at 105° C. for 10 minutes and then peeled from the substrates and placed on PTFE coated metal plates. The plate was placed in a 150° C. heating oven for another 3 hours. The obtained films were subjected to the Coefficient of Thermal Expansion (CTE) Test Method (described above).

TABLE 5
Room temperature curing of products and the effect of amino silanes on the stability of
products in solutions

| | | | 365 nm LED UV | |
|---|---|---|---|---|
| | | PFE-1 | exposure at 330 mW | |
| | Amine | solution | for 2 minutes, dried | |
| | Additives, | concentration, | and cured at room | 50° C. two |
| EX. | wt. % | wt. % | temperature | weeks |
| EX-20 | 0.5% KH-550 | 3% | Film does not dissolve | Transparent, |
| | | | in HFE-7300 | viscosity does |
| | | | | not change |
| EX-21 | 1.5% KH550 | 3% | Film does not dissolve | Transparent, |
| | | | in HFE-7300 | viscosity does |
| | | | | not change |
| EX-22 | 2.5% KH 550 | 3% | Film does not dissolve | Viscosity |
| | | | in HFE-7300 | builds up |
| EX-23 | 5% KH 550 | 3% | Film does not dissolve | Viscosity |
| | | | in HFE-7300 | builds up |
| EX-24 | 5% KH 550 | 6% | Film does not dissolve | Gel |
| | | | in HFE-7300 | |
| EX-25 | 0.5% | 3% | Film does not dissolve | Transparent, |
| | BAPTMA | | in HFE-7300 | viscosity does |
| | | | | not change |
| EX-26 | 1.5% | 3% | Film does not dissolve | Transparent, |
| | BAPTMA | | in HFE-7300 | viscosity does |
| | | | | not change |
| EX-27 | 2.5% | 3% | Film does not dissolve | Viscosity |
| | BAPTMA | | in HFE-7300 | builds up |
| EX-28 | 5% | 3% | Film does not dissolve | Viscosity |
| | BAPTMA | | in HFE-7300 | builds up |
| EX-29 | 5% | 6% | Film does not dissolve | Gel |
| | BAPTMA | | in HFE-7300 | |

In a control experiment, a 3 wt. % solution containing PFE-1 and 1.5% KH 550 were well mixed and sealed. The solution was placed in a 50° C. oven for two weeks. White flocculents were observed floating in the solution.

### Salt Spray Test Method

The salt spray test method was conducted according to ASTM B117. In detail, specimens are placed in an enclosed chamber and exposed to a continuous indirect spray of salt water solution which falls-out on to the specimens at a rate of 1.0 to 2.0 mL/80 cm²/hour, in a chamber temperature of +35° C. The pH of the salt solution fall-out should be maintained at a neutral pH (pH 6.5 to 7.2). The chamber climate is maintained under constant steady state conditions. The test duration is 5 days.

TABLE 6
Protection of metals using the perfluoroelastomers fabricated
by UV reaction

| | | PFE-1 | 365 nm LED UV exposure at |
|---|---|---|---|
| | Amine | solution | 330 mW for 2 minutes, coated |
| | additives, | concentration, | on copper plate, salt spray test; |
| EX. | wt. % | wt. % | results reported after 1 week |
| EX-30 | None | 3% | Corrosion |
| EX-31 | 0.5% KH-550 | 3% | Well protected |
| EX-32 | 1.5% KH550 | 3% | Well protected |
| EX-33 | 2.5% KH 550 | 3% | Well protected |
| EX-34 | 5% KH 550 | 3% | Well protected |
| EX-35 | 0.5% | 3% | Well protected |
| | BAPTMA | | |
| EX-36 | 1.5% | 3% | Well protected |
| | BAPTMA | | |
| EX-37 | 2.5% | 3% | Well protected |
| | BAPTMA | | |
| EX-38 | 5% BAPTMA | 3% | Well protected |

TABLE 7
CTE data of PFE-1/silica particles/silane composite films by
different procedures

| | | CTE ppm/° C. (tested |
|---|---|---|
| EX | COMPOSITION AND CONDITIONS | from 50-180° C.) |
| | 15 wt. % PFE-1 solution in HFE- | 225 ppm/° C. |
| | 7300:CQ0382:KH550 = 247:63:5 wt. | |
| | ratio; UV exposure on PFE-1 solutions, | |
| | then blend silica (50 wt. %) in the | |
| | solutions, then coat films on PET liners. | |
| | The films were dried and undergo curing | |
| | at room temperature. | |
| | 15 wt. % PFE-1 solution in HFE- | 278 ppm/° C. |
| | 7300:CQ0382:KH550 = 267:60:5, UV | |
| | exposure on PFE-1 solutions, then blend | |
| | silica (50 wt. %) in the solutions, then | |
| | coating films on PET liners. The films | |
| | were dried and undergo curing at room | |
| | temperature. | |
| | 15 wt. % PFE-1 solution in HFE- | 238 ppm/° C. |
| | 7300:CQ0382:KH550 = 247:63:2.5, UV | |
| | exposure on PFE-1 solutions, then blend | |
| | silica (50 wt. %) in the solution, then | |
| | coating films on PET liners. The films | |
| | were dried and undergo curing at room | |
| | temperature. | |
| | 15 wt. % PFE-1 solution in HFE- | Film break due to |
| | 7300:CQ0382:KH550 = 247:63:5, blend- | weak film strength |
| | ing silica (50 wt. %) in the solution, | during measurement |
| | then coating films on PET liners. The | |
| | films were dried and then undergo UV | |
| | exposure (365 nm LED UV exposure | |
| | at 330 mW for 2 minutes). | |

1. An electronic telecommunication article comprising a crosslinked fluoropolymer layer comprising fluoropolymer particles having a particle size of greater than one micron, wherein the fluoropolymer comprises at least 80, 85, or 90% by weight of polymerized units of perfluorinated monomers and cure sites.

2. The electronic telecommunication article of claim 1 wherein the crosslinked fluoropolymer layer is a substrate, patterned (e.g. photoresist) layer, insulating layer, passivation layer, cladding, protective layer, or a combination thereof.

3. The electronic telecommunication article of claim 1 wherein the article is an integrated circuit or printed circuit board or antenna or optical cable.

4-6. (canceled)

7. The electronic telecommunication article of claim 1 wherein the crosslinked fluoropolymer layer has
i) a dielectric constant (Dk) of less than 2.75, 2.70, 2.65, 2.60, 2.55, 2.50, 2.45, 2.40, 2.35, 2.30, 2.25, 2.20, 2.15, 2.10, 2.05, 2.00, or 1.95;
ii) a dielectric loss of less than 0.01, 0.009, 0.008, 0.007, 0.006, 0.005, 0.004, 0.003, 0.002, 0.001, 0.0009, 0.0008, 0.0007, or 0.0006;
or a combination thereof.

8. The electronic telecommunication article of claim 1 wherein the fluoropolymer further comprises cure sites selected from nitrile, iodine, bromine, and chlorine.

9. The electronic telecommunication article of claim 1 wherein the perfluorinated monomers are selected from tetrafluoroethene (TFE) and one or more unsaturated perfluorinated alkyl ethers,

10. The electronic telecommunication article of claim 9 wherein the unsaturated perfluorinated alkyl ether of the fluoropolymer has the general formula
R_{f}—O—(CF₂)ₙ—CF═CF₂
wherein n is 1 or 0 and Rf is a perfluoroalkyl or perfluoroether group.

11. The electronic telecommunication article of claim 1 wherein the crosslinked fluoropolymer is crosslinked with a curing agent selected from
i) a peroxide and an ethylenically unsaturated compound;
ii) one or more compounds comprising an electron donor group including amine curing agents and an ethylenically unsaturated group; or
iii) an amino organosilane ester compound or ester equivalent.

12. The electronic telecommunication article of claim 1 wherein the curing agent comprises at least two ethylenically unsaturated groups or at least one ethylenically unsaturated group and at least one alkoxy silane group.

13-14. (canceled)

15. The electronic telecommunication article of claim 1 wherein the fluoropolymer comprises 40 to 60% by weight of polymerized units of TFE based on the total weight of the fluoropolymer.

16. The electronic telecommunication article of claim 1 wherein the crosslinked fluoropolymer comprises no greater than 5, 4, 3, 2, 1 or 0.1 wt.-% of polymerized units derived from non-fluorinated or partially fluorinated monomers and/or comprises no greater than 5, 4, 3, 2, 1 or 0.1 wt. % of ester-containing linkages.

17. The electronic telecommunication article of claim 1 wherein the crosslinked fluoropolymer is insoluble in 3-ethoxy perfluorinated 2-methyl hexane or 3-methoxy perfluorinated 4-methyl pentane.

18. The electronic telecommunication article of claim 1 wherein the crosslinked fluoropolymer layer comprises 10 to 80 wt. % fluoropolymer particles having an average particle size of at least one micron.

19. The electronic telecommunication article of claim 1 wherein the fluoropolymer particles have a greater amount of polymerized units of TFE than the crosslinked fluoropolymer.

20. The electronic telecommunication article of claim 1 wherein the crosslinked fluoropolymer layer further comprises submicron crystalline fluoropolymer particles.

21. The electronic telecommunication article of claim 1 wherein the crosslinked fluoropolymer layer further comprises silica, glass fibre, thermally conductive filler or a combination thereof.

22. The electronic telecommunication article of claim 21 wherein the silica is fumed silica, fused silica, glass bubbles, or a combination thereof.

23. The electronic telecommunication article of claim 22 wherein the fumed or fused silica has an aggregate particle size of at least 500 nm, 1 micron, 1.5 microns, or 2 microns.

24. The electronic telecommunication article of claim 21 wherein the silica comprises a hydrophobic surface treatment optionally comprising a fluorinated alkoxy silane compound.

25. The electronic telecommunication article of claim 21 wherein the silica is present in an amount of at least 10, 20, 30, 40, 50, 60, or 70 wt. % based on the total amount of the crosslinked fluoropolymer layer.

26-53. (canceled)
